(19) United States
(12) Patent Application Publication
(10) Pub. No.: US 2014/0095361 A1
(43) Pub. Date: Apr. 3, 2014

(54) SUPPLY CHAIN FINANCIAL ORCHESTRATION SYSTEM WITH TRADE ACCOUNTING

(71) Applicant: Oracle International Corporation, Redwood Shores, CA (US)

(72) Inventors: Shyam Sundar SANTHANAM, Redwood City, CA (US); Siddharth KHANNA, Austin, TX (US); Jatinder GOGNA, Baldwin Place, NY (US); Sunil Sama REDDY, San Carlos, CA (US); Srinath Reddy KAYITHA, Foster City, CA (US)

(73) Assignee: Oracle International Corporation, Redwood Shores, CA (US)

(21) Appl. No.: 14/028,686

(22) Filed: Sep. 17, 2013

Related U.S. Application Data
(60) Provisional application No. 61/707,630, filed on Sep. 28, 2012.

(51) Int. Cl. G06Q 40/00

(52) U.S. Cl. CPC G06Q 40/12
USPC 705/30

(57) ABSTRACT

A system that processes trade events is provided. The system receives events associated with a supply chain financial orchestration flow, where a supply chain financial orchestration flow defines a trade relationship between a first entity and a second entity. The system further determines whether at least one event indicates an ownership change of an item between a first entity and a second entity. The system further generates trade events where at least one event indicates an ownership change. The system further sends the trade events to a cost accounting system. The cost accounting system further performs accounting based on the trade events and generates trade accounting events.

### CROSS-REFERENCE TO RELATED APPLICATIONS

This application claims priority of U.S. Provisional Patent Application Ser. No. 61/707,630, filed on Sep. 28, 2012, the subject matter of which is hereby incorporated by reference.

### FIELD

One embodiment is directed to a computer system, and more particularly, to a computer system that orchestrates supply chain financial processes.

### BACKGROUND

Large multi-national companies, or other enterprises, often operate through a number of subsidiary companies, or other legal entities, spread across the globe. These subsidiary companies can be further divided into business units or lines of businesses. The intersection of each subsidiary company and line of business (identified as a “profit center business unit”) can become a supply chain entity that engages in manufacturing, purchase, and/or sale of goods and services.

The profit center business units typically engage commercially with an external supply chain, such as a collection of suppliers and customers. They can also engage in internal trades, or internal transfers, within the subsidiary company. One example type of an internal trade is an “inter-company trade,” where a profit center business unit belonging to one subsidiary company trades with a profit center business unit belonging to another subsidiary company, at arm's length terms and conditions. Another example type of an internal trade is an “intra-company trade,” where two profit center business units belonging to the same subsidiary company trade among each other on a competitive basis. These types of trades typically fall under “management accounting” based performance management, where each profit center business unit is rewarded for the value it adds to the supply chain.

### SUMMARY

One embodiment is a system that processes trade events. The system receives events associated with a supply chain financial orchestration flow, where a supply chain financial orchestration flow defines a trade relationship between a first entity and a second entity. The system further determines whether at least one event indicates an ownership change of an item between the first entity and the second entity. The system further generates trade events where at least one event indicates an ownership change. The system further sends the trade events to a cost accounting system. The cost accounting system further performs accounting based on the trade events and generates trade accounting events.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates an example enterprise structure, an example inter-company trade agreement, and an example intra-company trade agreement, according to an embodiment of the invention.

FIG. 3 illustrates an example integration of a supply chain financial orchestration system with a cost accounting system, according to an embodiment of the invention.

FIG. 4 illustrates an example diagram of a supply chain financial orchestration system that processes trade events, according to an embodiment of the invention.

FIG. 5 illustrates an example diagram of a cost accounting system that performs accounting based on trade events received from a supply chain financial orchestration system, according to an embodiment of the invention.

FIG. 6A illustrates trade accounting events generated for a forward flow of a global procurement flow, according to an embodiment of the invention.

FIG. 6B illustrates trade accounting events generated for a return flow of a global procurement flow, according to an embodiment of the invention.

FIG. 7A illustrates trade accounting events generated for a forward flow and a return flow of a customer shipment flow, according to an embodiment of the invention.

FIG. 7B illustrates forward and return variations of a customer shipment flow, according to an embodiment of the invention.

FIG. 8A illustrates trade accounting events generated for a forward flow and a return flow of a customer drop shipment flow where there is a single business unit drop shipment, according to an embodiment of the invention.

FIG. 8B illustrates trade accounting events generated for a forward flow and a return flow of a customer drop shipment flow where the selling legal entity is also the requisitioning legal entity, according to an embodiment of the invention.

FIG. 8C illustrates trade accounting events generated for a forward flow and a return flow of a customer drop shipment flow where the requisitioning legal entity is also the “sold-to” legal entity, according to an embodiment of the invention.

FIG. 8D illustrates trade accounting events generated for a forward flow and a return flow of a customer drop shipment flow where the sold-to legal entity, requisitioning legal entity, and selling legal entity are all different, according to an embodiment of the invention.

FIG. 9A illustrates trade accounting events generated for a forward flow of an internal transfer flow, according to an embodiment of the invention.

FIG. 9B illustrates trade accounting events generated for a return flow of an internal transfer flow, according to an embodiment of the invention.

FIG. 9C illustrates trade accounting events generated for a forward flow of an internal transfer flow within a single profit center business unit, according to an embodiment of the invention.

FIG. 9D illustrates trade accounting events generated for a return flow of an internal transfer flow within a single profit center business unit, according to an embodiment of the invention.

FIG. 9E illustrates forward and return variations of an internal transfer flow, according to an embodiment of the invention.

FIG. 10 illustrates an example gross margin reporting data model, according to an embodiment of the invention.

FIG. 11 illustrates a flow diagram for a process that collects COGS and revenue data for a COGS object and a revenue object of a gross margin reporting data model, according to an embodiment of the invention.

FIG. 12 illustrates an example user interface of a gross margin reporting data model, according to an embodiment of the invention.

FIG. 13 illustrates another example user interface of a gross margin reporting data model, according to an embodiment of the invention.

FIG. 14 illustrates a flow diagram of the functionality of a supply chain financial trade accounting module, according to an embodiment of the invention.

FIG. 15 illustrates a flow diagram of the functionality of a supply chain financial trade accounting module that utilizes a unified gross margin computation model for intercompany trade events as well as physical sales order flows, according to another embodiment of the invention.

FIG. 16 illustrates an example supply chain financial orchestration flow, according to an embodiment of the invention.

FIG. 17 illustrates a block diagram of an example architecture of a supply chain financial orchestration system, according to an embodiment of the invention.

### DETAILED DESCRIPTION

According to an embodiment, a supply chain financial orchestration system is provided that can capture, process, and perform an accounting of the buy-sell trade events that emanate from complex supply chain financial flows, such as internal trades within an enterprise. The system can receive buy-sell trade events, where a buy-sell trade event (or trade event) is a buy, sell, or in-transit movement event that results from a complex supply chain inter-/intra-company business flow. The system can further generate and process buy-sell trade accounting events that are independent from the physical movement of goods and/or services related to the supply chain financial flows, where a buy-sell trade accounting event (or trade accounting event) is an accounting event for a trade event. The system can standardize a trade accrual and trade cost accounting information, and can provide a unified mechanism to perform the accounting of the trade accounting events arising from supply chain financial flow, such as global procurement of goods and/or services, drop shipments of goods and/or services, and inter-organizational transfers of goods and/or services.

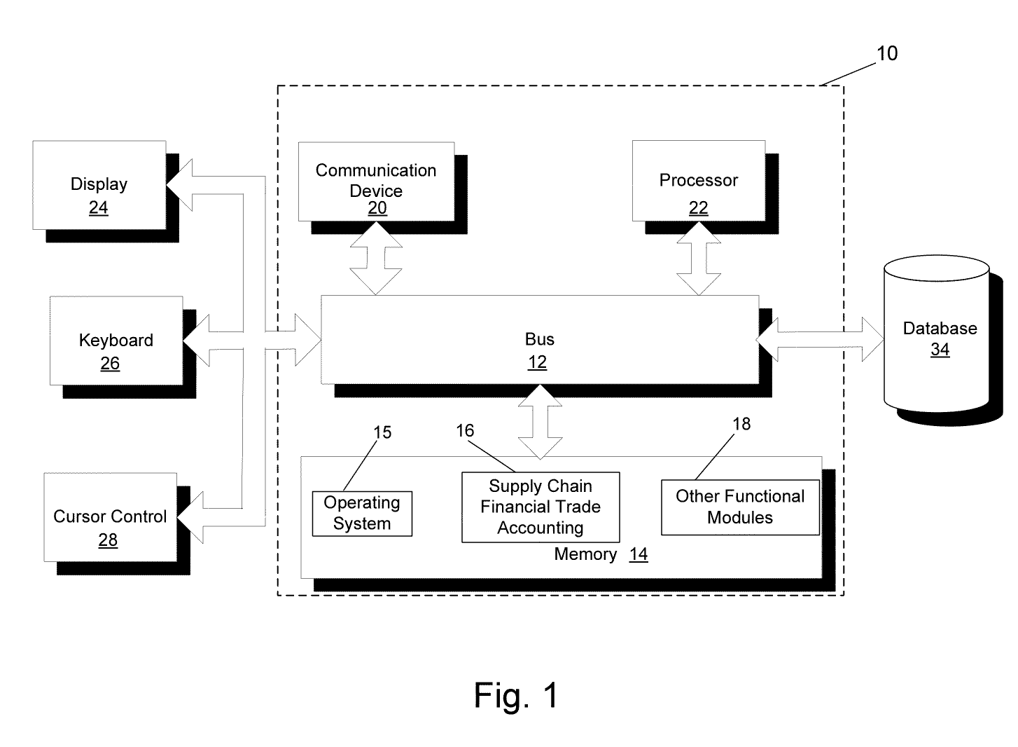

FIG. 1 illustrates a block diagram of a supply chain financial orchestration system 10 that may implement one embodiment of the invention. Supply chain financial orchestration system 10 includes a bus 12 or other communications mechanism for communicating information between components of supply chain financial orchestration system 10. Supply chain financial orchestration system 10 also includes a processor 22, operatively coupled to bus 12, for processing information and executing instructions or operations. Processor 22 may be any type of general or specific purpose processor. Supply chain financial orchestration system 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. Supply chain financial orchestration system 10 further includes a communication device 20, such as a network interface card or other communications interface, to provide access to a network. As a result, a user may interface with supply chain financial orchestration system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with supply chain financial orchestration system 10.

According to one embodiment, memory 14 can store software modules that may provide functionality when executed by processor 22. The modules can include an operating system 15, a supply chain financial trade accounting module 16, as well as other functional modules 18. Operating system 15 can provide an operating system functionality for supply chain financial orchestration system 10. Supply chain financial trade accounting module 16 can provide functionality for processing trade events, as is described in more detail below. In certain embodiments, supply chain financial trade accounting module 16 can comprise a plurality of modules that each provide specific individual functionality for processing trade events. Supply chain financial orchestration system 10 can also be part of a larger system. Thus, supply chain financial orchestration system 10 can include one or more additional functional modules 18 to include the additional functionality. For example, functional modules 18 may include modules that provide additional functionality, such as one or more “Oracle Fusion Applications” from Oracle Corporation. In another example, functional modules 18 may include enterprise resource planning (“ERP”) modules of an ERP system, where an ERP system is a computer system that integrates several data sources and processes of an organization into a unified system.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

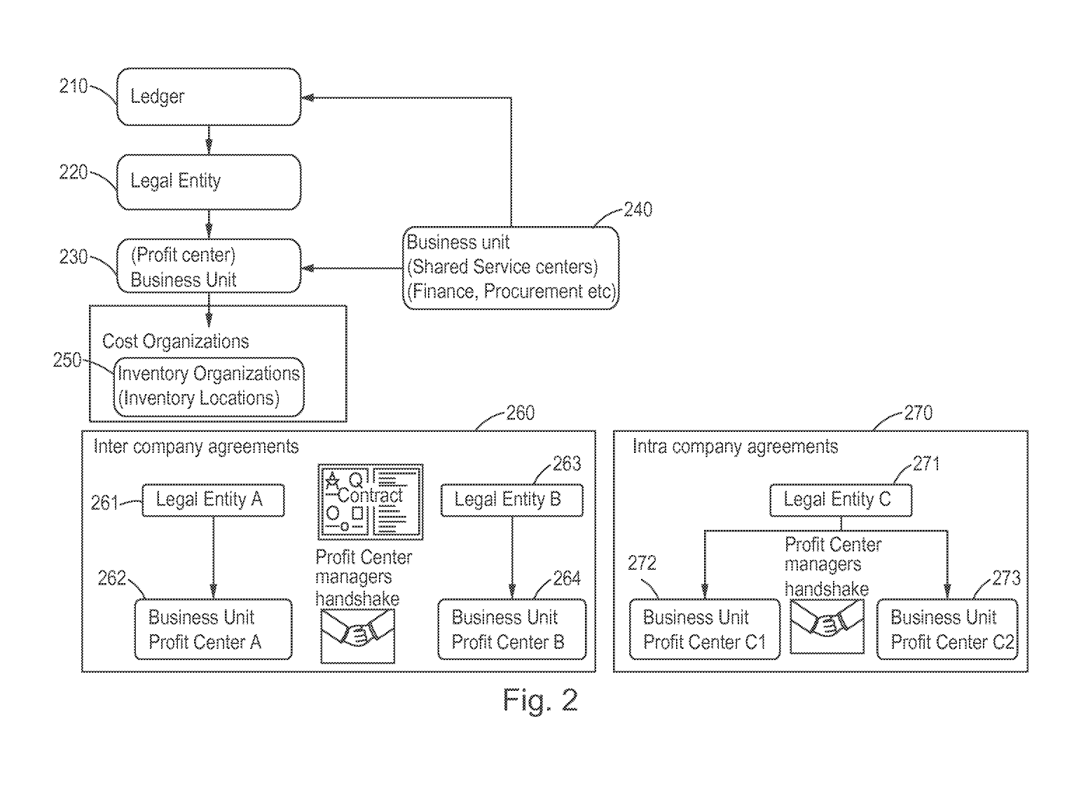

FIG. 2 illustrates an example enterprise structure, an example inter-company trade agreement, and an example intra-company trade agreement, according to an embodiment of the invention. As previously described, a large enterprise can operate through a number of legal entities. According to the embodiment, an enterprise can operate under an enterprise structure, such as the enterprise structure illustrated in FIG. 2, where an enterprise can be divided into one or more legal entities (or alternatively, business entities), represented by legal entity 220 in FIG. 2, where the financial transactions of each legal entity are recorded against a ledger, represented by ledger 210 in FIG. 2. Further, a legal entity can be divided into one or more business units, where a business unit can either be a profit unit, represented by business unit 230 in FIG. 2, or a shared service center, represented by business unit 240 in FIG. 2. Each business unit can be divided into one or more cost/inventory organizations, represented by inventory organization 250 in FIG. 2, where an inventory organization represents an organization level within a business unit where information regarding all inventory (such as goods and/or services) is consolidated. A profit center business unit (or business unit), and all of its inventory organizations, belong to the corresponding legal entity.

As also previously described, an enterprise can engage in internal trades. In these types of internal trades, the enterprise does not trade with another legal entity (or alternatively, a business entity). Instead, a legal entity (or sub-entity) of the enterprise engages in a trade with another legal entity (or sub-entity) of the enterprise. An example of an internal trade is an inter-company trade, represented by inter-company trade agreement 260 in FIG. 2. In an inter-company trade, a first legal entity of an enterprise, represented by legal entity 261 in FIG. 2, owns a first profit center business unit, represented by business unit 262 in FIG. 2. Further, a second legal entity of the enterprise, represented by legal entity 263 in FIG. 2, owns a second profit center business unit, represented by business unit 264 in FIG. 2. The first profit center business unit enters into a trade agreement with the second profit center business unit. Thus, the trade agreement is between two legal entities within the enterprise.

A real-world example of an inter-company trade agreement is a trade agreement between a manufacturing plant of a company located in China, and a sales office of the company located in the United States. The Chinese manufacturing plant can enter in a trade agreement with the United States sales office to transfer ownership of goods physically located in a warehouse of the Chinese manufacturing plant to the Unites States sales office, so that the goods can be sold to customers located in the United States. The Chinese manufacturing plant represents a first legal entity of the company, where the Chinese manufacturing plant owns its own profit center business unit. The United States sales office represents a second legal entity of the company, where the United States sales office also owns its own profit center business unit. The profit center business unit of the Chinese manufacturing plant can enter into the trade agreement with the profit center business unit of the United State sales office, and thus, the trade agreement is between two legal entities within the company.

Another example of an internal trade is an intra-company trade, represented by intra-company trade agreement 270 in FIG. 2. In an intra-company trade, a legal entity (or alternatively, a business entity) of an enterprise, represented by legal entity 271 in FIG. 2, owns a first profit center business unit, represented by business unit 272 in FIG. 2, and owns a second profit center business unit, represented by business unit 273 in FIG. 2. The first profit center business unit enters into a trade agreement with the second profit center business unit. Thus, the trade agreement is within a single legal entity of the enterprise.

A real-world example of an intra-company trade agreement is a trade agreement between a first profit center business unit of a company's manufacturing plant located in China, and a second profit center business unit of the company's manufacturing plant located in China. The two profit center business units can be focused on different target markets of the relevant industry. The first profit center business unit can enter into a trade agreement with the second profit center business unit to transfer ownership of goods physically located in a warehouse of the Chinese manufacturing plant. Because both profit center business units belong to the Chinese manufacturing plant, the trade agreement is within a single legal entity of the company.

Both inter-company trade agreements and intra-company trade agreements have unique business challenges. Such challenges include: (1) an ability to define a buy-sell business relationship between the two profit center business units in a transparent way; (2) an ability to track and maintain an audit trail of ownership of goods, as well as physical custody of goods; (3) an ability to maintain an original cost of goods separate from mark-ups added to them as part of a transfer price; (4) an ability to account for financial ownership changes without changes to physical custody of goods; (5) an ability to account for in-transit goods independent of goods whose physical movements are tracked; (6) an ability to standardize the accounting into a unified set of accounting events, even though the events may be originating out of many types of inter-/intra-company flows; and (7) an ability to configure the accounting entries to be created based on a nature of the trade, a nature of the goods, parties involved and documentation required.

Many of the aforementioned challenges arise from the fact that, in inter-company trade agreements and intra-company trade agreements, physical goods typically follow a supply path that is different from an ownership path. Taking the aforementioned example of the company that includes a Chinese manufacturing plant and a United States sales office, when the United States sales office books a sale in the United States, the physical goods associated with the sale can be delivered from the Chinese manufacturing plant directly to the customer in the United States. However, the ownership path of the goods is not the same as the physical movement path of the goods. Instead, the ownership path starts at the Chinese manufacturing plant, proceeds to the United States sales office, and then proceeds to the customer. This is because, as part of the sale, the Chinese manufacturing plant and the United States sales office enters into an inter-company trade agreement, where the Chinese manufacturing plant transfers ownership of the goods to the United States sales office, so that the United States sales office can sell the goods to the customer. However, while there is an ownership transaction between the Chinese manufacturing plant and the United States sales office, there is no corresponding physical transaction between these two legal entities, because there is no physical movement of the goods between the two legal entities. For example, the Chinese manufacturing plant may ship the goods to a Singapore subsidiary, the Singapore subsidiary may ship the goods to a United States subsidiary (which is separate from the United State sales office), and the United States subsidiary may ship the goods directly to the customer. In the aforementioned example, there is no physical movement of the goods from the Chinese manufacturing plant to the United States sales office. Because most conventional ERP systems perform accounting based on physical movement of goods, these systems typically cannot accurately track trades where the ownership movement of the goods is independent of the physical movement of the goods. Thus, such ERP systems are not complete and robust in accounting for internal trades.

Conventional ERP systems typically resort to one or more of the following approaches to handle internal trades. One approach is to synthesize physical movement (e.g., artificial legs of purchase orders or sales order) that mirror the ownership movement. However, this approach leads to inaccurate reporting, as the ERP systems indicate physical movements of the goods that the goods did not, in fact, make. Further, the approach leads to increased inventory cost accounting, as inventory cost accounting is required to be performed for physical movement of goods that did not actually happen. Another approach is to customize the ERP systems and add software modules, such as plug-in modules, to handle internal trades, or buy “off-the-shelf” software that provides functionality for handling internal trades. However, such customizations, and off-the-shelf software, are typically investment-intensive projects that take a number of years to build and stabilize, which increases design time to design new business flows. Further, the customizations, and the off-the-shelf software, often are not scalable to business changes, and can severely restrict companies in adopting new business models and upgrades to new ERP versions. Finally, such customizations, and off-the-shelf-software, are typically incomplete and do not meet all the requirements described above.

In order to address these problems, and to meet the requirements previously described, in one embodiment, a supply chain financial orchestration system is provided that includes a distinct trade accounting model. The supply chain financial orchestration system can receive trade events from one or more external applications. The supply chain financial orchestration system can enrich each trade event with cost accounting information in order to create a trade accounting event for each trade event, and can send each trade accounting event to an external cost accounting system, where the external cost accounting system can create accounting entries based on each trade accounting event, using the cost accounting information included within each trade accounting event.

More specifically, the supply chain financial orchestration system can provide inter-company and intra-company financial setup for supply chain business flows. The supply chain financial orchestration system can orchestrate the execution of trade events through trade routes by creating appropriate trade accounting events in external costing, payable, and receivable systems, as well as creating appropriate trade documents in external purchasing and sales order systems. The external costing, payable, and receivable systems can process the trade accounting events to create the appropriate accounting entries, and the external purchasing and sales order systems can process the trade documents.

Thus, the supply chain financial orchestration system can provide a way to track an intercompany transaction that is independent of a physical movement of goods. This allows for trade accounting to be performed, where the trade accounting is separate from inventory transaction cost accounting. This independent tracking is part of a trade accounting model that can establish a cost structure, and perform cost accounting, based on a trade event, as if the trade event is an actual physical transaction. The cost accounting can be rule-based, where one or more documentation and accounting rules are applied based on configured settings and captured relevant accounting attributes, as described below in greater detail. Further, in contrast to previous ERP systems where transactions were typically executed in an inventory execution system, and accounted in a cost accounting system, a separate system can produce trade events that can be independent of physical events, such as buy-sell trade accounting events that emanate from inter-/intra-company business flows. Thus, events that are not part of an inventory execution system can be accounted for.

As a real-world example, taking the aforementioned scenario of the company that includes a Chinese manufacturing plant and a United States sales office, there can be two paths: an ownership path where ownership moves from the Chinese manufacturing plant, to the United States sales office, and to the U.S. customer; and a physical custody path where the goods physically move from the Chinese manufacturing plant to the U.S. customer. In this scenario, a trade accounting model of the supply chain financial orchestration system can book a trade agreement between the Chinese manufacturing plant and the United States sales office. The supply chain financial orchestration system can receive trade events associated with the change of ownership of the goods, enrich the trade events with cost accounting information to create trade accounting events, and can send the trade accounting events to an external cost accounting application to create appropriate accounting entries based on the trade accounting events.

According to an embodiment, the trade accounting model of the supply chain financial orchestration system can provide significant new capabilities. One significant capability is a separation of trade events from an inventory execution system. In previous ERP systems, trade events were almost always part of an inventory execution system. In order for the inventory execution system to process a trade event, a trade event would have to be categorized as a physical inventory transaction, which was not always correct, as the trade event did not necessarily require physical movement of goods. This frustrated some customers of the ERP systems, as they did not always want to have trade events forming part of the inventory system. The trade accounting model separates the trade events from the physical inventory transaction events, where trade accounting events that correspond to the trade events can be directly created in an external cost accounting system.

Another significant capability is an ability to enable a physical execution to be performed without a concern about any ownership changes. By separating out trade events from an inventory system, and modeling the trade events in a costing system, a physical execution, such as a sale shipment, is no longer dependent on a creation of a trade event as a prerequisite.

Yet another significant capability is a separation of a trade accounting model from a core cost accounting model for physical inventory transactions. This is a major design improvement that can enable costing of trade events at actual costs. Prior ERP systems could be influenced by a cost method used for inventory valuation of physical goods. In these systems, the accounting for trade events could potentially be held back because of a pending cost accounting of a physical inventory transaction. This separation can facilitate an independent cost processing of these trade events.

Another significant capability is a true cost accounting for trade events. Many earlier ERP systems were not able to establish a cost structure for trade events. They were not able to add additional costs such as overheads to incoming costs. The trade accounting model can enable mapping of incoming costs into cost elements, as well as providing an ability to configure overhead rules on top of the incoming costs. The trade events can have an in-depth cost structure that is similar to a cost structure of any other physical inventory transaction. Thus, this is a capability not commonly found in previous ERP systems.

Yet another significant capability is configurable accounting templates for trade events. The trade accounting model can carry the accounting attributes that dictate the accounting debits and credits that are required. For example, if inter-company invoicing is enabled, the accounting can require the use of an inter-company cost of goods sold (“COGS”) accounting. The trade accounting model can capture these accounting attributes efficiently, which is a new capability.

Another significant capability is an ability to establish a linkage among trade events. An important requirement is an ability to track costs and internal mark-ups separately in a cost structure. Typically, ERP systems do not have the capability to separate these in a cost structure. In the trade accounting model, the trade events can be stamped with certain common accounting attributes, as well as attributes that chain the trade events from one to another. This can facilitate seamless tracking of costs and internal mark-ups as a product moves through a supply chain.

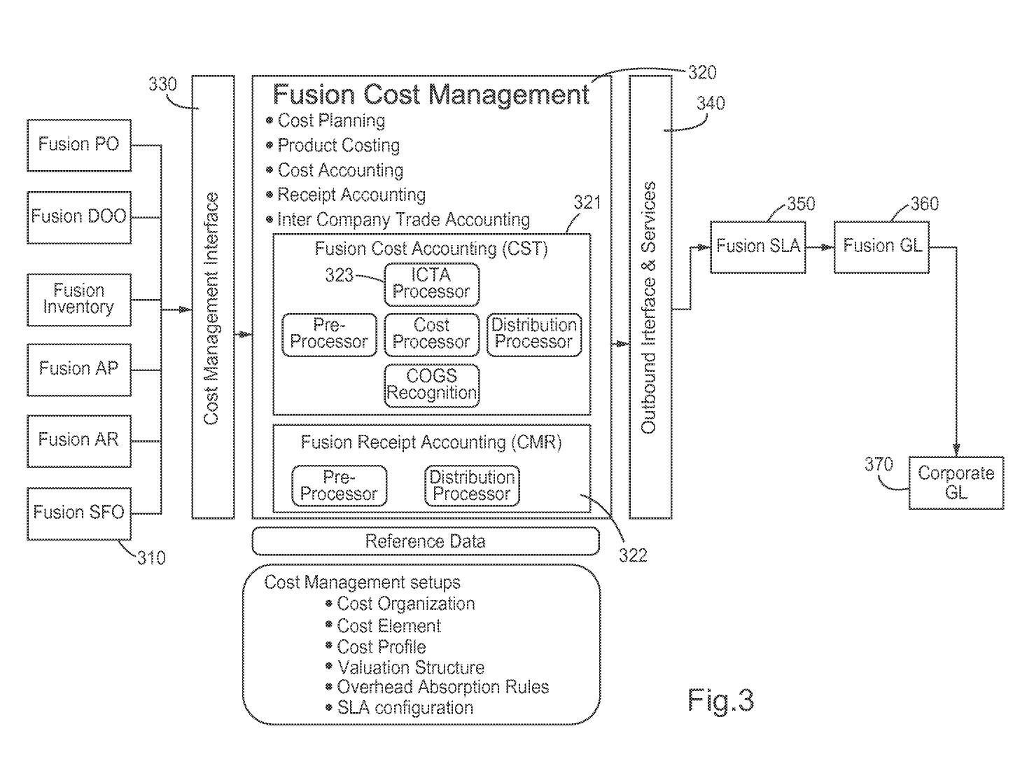

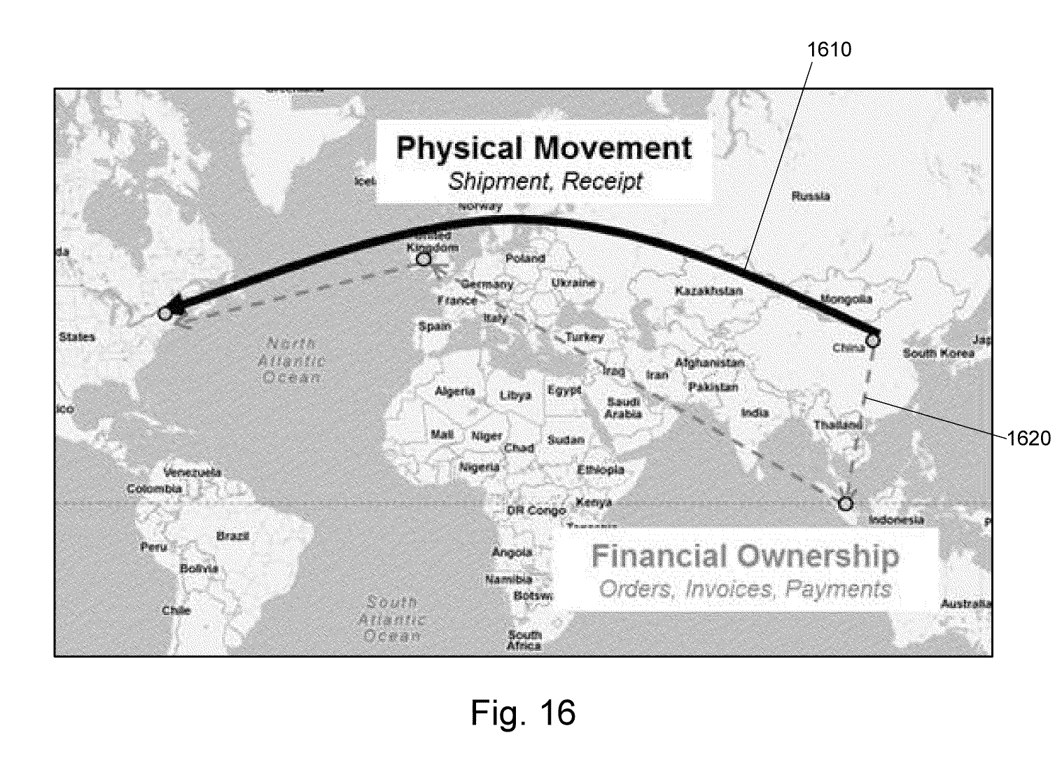

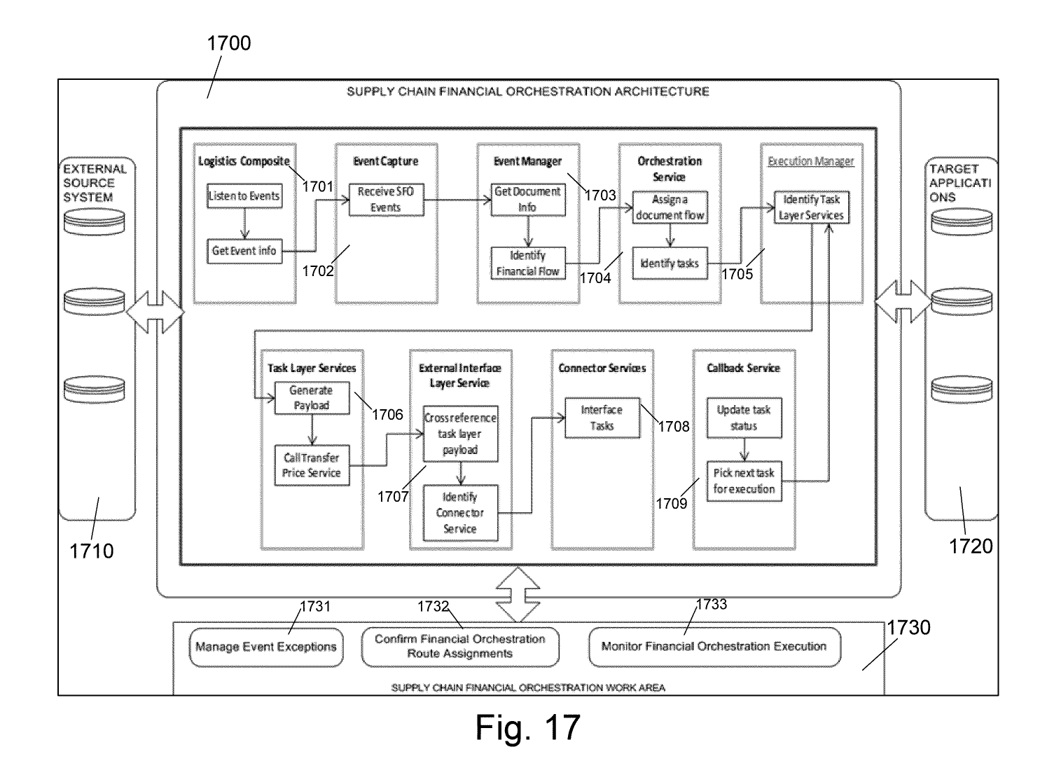

FIG. 3 illustrates an example integration of a supply chain financial orchestration system 310 with a cost accounting system 320, according to an embodiment of the invention. According to an embodiment, one or more legal/business entities can be defined as entities for a supply chain financial orchestration flow within supply chain financial orchestration system 310. A supply chain financial orchestration flow defines a trade relationship between a first entity and a second entity. The trade relationship can be an inter-company trade, and the first entity can be a profit center business unit of a first legal entity, and the second entity can be a profit center business unit of a second legal entity. Alternatively, the trade relationship can be an intra-company trade, and the first entity can be a profit center business unit of a legal entity, and the second entity can be a profit center business unit of the same legal entity. An example supply chain financial orchestration flow is further described below in conjunction with FIG. 16, and example architecture of a supply chain financial orchestration system is further described below in conjunction with FIG. 17. Further, one or more terms and/or conditions can be defined for the supply chain financial orchestration flow within supply chain financial orchestration system 310. Such terms and/or conditions can include documentation and accounting rules that can define one or more tasks to be performed in response to an event. Further, such terms and/or conditions can include transfer pricing rules that can define a transfer price used in a transaction between one or more entities of the supply chain financial orchestration flow. Example transfer pricing rules can include “cost+10%” (which sets a transfer price to a cost of an item plus 10% of the cost of the item), “fixed transfer pricing” (which sets a transfer price to a fixed amount), etc. Further, an accounting policy can be defined for the supply chain financial orchestration flow within supply chain financial orchestration system 310. Example accounting policies include whether an invoice should be generated, whether to track profits based on markups for internal transactions between two inter-company entities or two intra-company entities, etc.

In one embodiment, an ownership change definition can be defined within supply chain financial orchestration system 310. More specifically, an event, such as a physical execution event (also identified as a physical transaction) that determines an ownership change can be defined within supply chain financial orchestration system 310. An example ownership change definition can include a definition that ownership changes when physical goods are shipped from a first legal entity to a second legal entity. Another example ownership change definition can include a definition that ownership changes from a first legal entity to an intermediate legal entity when physical goods are shipped from the first legal entity to the intermediate legal entity, that ownership remains with the intermediate legal entity until the physical goods arrive at a second legal entity, and that ownership changes from the intermediate legal entity to the second legal entity when the physical goods arrive at the second legal entity.

According to the embodiment, an inventory system can record transactions associated with a supply chain financial orchestration flow, where a transaction can raise an event, such as a physical execution event. In certain embodiments, the transaction can be an internal transaction. Supply chain financial orchestration system 310 can listen for, and receive, the event, and determine from the recorded transaction, and one or more configurations that are defined within supply chain financial orchestration system 310 (such as an ownership change definition), whether the event indicates an ownership change. Where an event indicates an ownership change, supply chain financial orchestration system 310 can generate one or more trade events and send the trade event(s) to external cost accounting system 320 using cost management interface 330. In one embodiment, supply chain financial orchestration system 310 can also send one or more accounting attributes used for cost accounting. Such accounting attributes can include one or more pricing attributes (which define a transfer price), one or more accounting template attributes (which define an accounting template, where an accounting template includes one or more documentation and accounting rules and/or one or more transfer pricing rules), one or more profit tracking attributes (which define whether to track mark-ups), etc. As illustrated in FIG. 3, cost accounting system 320 can also receive events sent by other systems.

Example supply chain financial orchestration flows include: a global procurement flow; a customer shipment flow; and an internal transfer flow. A global procurement flow is a supply chain financial orchestration flow where a central buying entity buys goods from suppliers on behalf of one or more internal entities. The supplier liability is borne by the purchasing entity. The purchasing and requesting entity settle the transaction among themselves using a transfer price (sometimes through one or more intermediary entities). A customer shipment flow is a supply chain financial orchestration flow in which a selling business unit is different from a profit center business unit of the entity that owns and ships the goods. The selling entity receives an order from a customer, and the shipping entity ships the goods directly to the customer. The shipping entity is settled financially by the selling entity (sometimes through one or more intermediary entities). A customer shipment flow can be an internal drop shipment flow, which is a forward customer shipment flow, or a customer drop shipment flow, which is a return customer shipment flow. An internal transfer flow is a supply chain financial orchestration flow in which physical movement of goods happens between internal entities. The internal entities settle the financial transactions among themselves using a transfer price.

Further, example trade events include: a trade receipt accrual; a trade in-transit receipt; a trade in-transit issue; a trade sales issue; a trade return accrual; a trade in-transit return; a trade in-transit return receipt; and a trade sales return. A trade receipt accrual is a trade event that represents a possession of ownership of goods independent of a physical position of the goods. A trade in-transit receipt is a trade event that represents goods entering in-transit status. A trade in-transit issue is a trade event that represents goods moving out of in-transit status. A trade sales issue is a trade event that represents a sale transaction that records a cost (or deferred cost) of goods sold. Trade receipt accruals, trade in-transit receipts, trade in-transit issues, and trade sales issues are associated with a forward flow for a supply chain financial orchestration flow. A trade return accrual is a trade event that represents a reversal of ownership of goods independent of a physical position of the goods due to a return transaction. A trade in-transit return is a trade event that represents goods exiting in-transit status due to a return transaction. A trade in-transit return receipt is a trade event that represents a possession of ownership of goods due to a return transaction. A trade sales return is a trade event that represents a sales return transaction that records a reversal of cost (or deferred cost) of goods sold due to a return transaction. Trade return accruals, trade in-transit returns, trade in-transit return receipts, and trade sales returns are associated with a return flow for a supply chain financial orchestration flow.

Even further, for a global procurement flow, example physical execution events include a purchase order (“PO”) receipt, a PO delivery, a PO return, a match, a correction, or a PO return to receiving. For a customer shipment flow, example physical execution events include a sales order issue, a return merchandise authorization (“RMA”) receipt, a drop shipment receipt, or a drop shipment delivery. For an internal transfer flow, example physical execution events include an in-transit shipment, an in-transit receipt, an in-transit receipt delivery, a transfer order shipment, a transfer order receipt, a transfer order delivery, a transfer order return to receiving, a transfer order return to shipping entity, or a transfer order return receipt.

According to the embodiment, cost accounting system 320 receives the trade events sent by supply chain financial orchestration 310, performs accounting for the received trade events, and generates one or more trade accounting events based on the received trade events. The accounting can include accounting for an item whose ownership is transformed from a first legal entity to a second legal entity. The accounting can also be based on a transfer price agreed upon by the two legal entities. The transfer price can be defined as part of an agreement (also identified as “buy and sell terms”) between the two legal entities. More specifically, cost accounting system 320 includes cost accounting component 321 and receipt accounting component 322. Cost accounting component 321 receives a first set of trade events, performs accounting for the first set of trade events, and generates one or more trade accounting events based on the first set of trade events. According to the embodiment, the first set of trade events can include trade events used to book a buy-sell trade agreement (e.g., trade in-transit receipts, trade in-transit issues, trade sales issues, trade in-transit returns, trade in-transit return receipts, and/or trade sales returns). Further, according to the illustrated embodiment, cost accounting component 321 includes an inter-company trade accounting (“ICTA”) processor 323 configured to process the first set of trade events, perform the accounting of the first set of trade events and generate the one or more trade accounting events based on the first set of trade events. ICTA processor 323 can be a stand-alone component that is agnostic to a specific cost method. This way, ICTA processor 323 can be run as an individual sub-processor within cost accounting system 320. Receipt accounting component 322 can receive a second set of trade events, perform an accounting of the second set of trade events, and generate one or more trade accounting events based on the second set of trade events. According to the embodiment, the second set of trade events can include trade events used to create inter-/intra-company accruals (e.g., trade receipt accruals and/or trade return accruals). Receipt accounting component 322 can further include one or more interfaces for trade events received from supply chain financial orchestration system 310.

According to the embodiment, cost accounting system 320 can, in parallel, receive events, such as physical execution events, from one or more other systems. Cost accounting system 320 can further, in parallel, process the physical execution events, and perform accounting for the received physical execution events. Thus, an accounting of trade events can be independent of an accounting of the physical execution events.

In accordance with the embodiment, cost accounting system 320 sends the trade accounting events to external cost accounting systems 350, 360, and 370 via outbound interface 340. The trade accounting events are further processed by external cost accounting systems 350, 360, and 370.

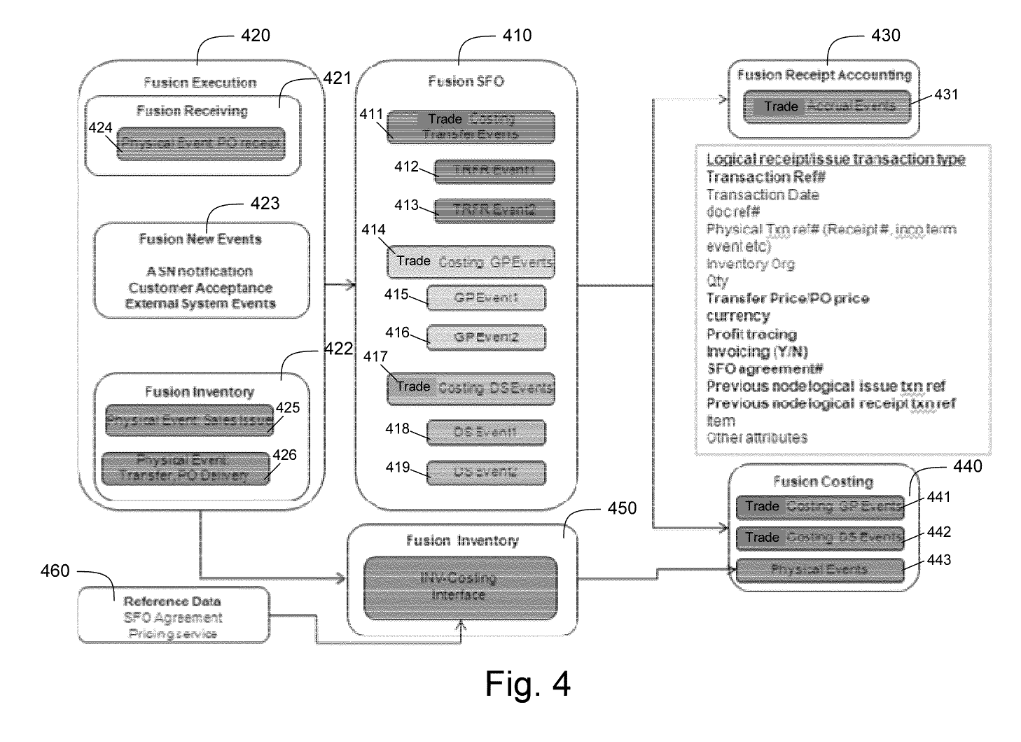

FIG. 4 illustrates an example diagram of a supply chain financial orchestration system 410 that processes trade events, according to an embodiment of the invention. The diagram illustrated in FIG. 4 includes execution systems 420, which represent systems that can execute supply chain financial orchestration flows. In the illustrated embodiment, execution systems include receiving execution system 421 which is an execution system that can record and transact receipts, and inventory execution system 422 which is an execution system that can manage inventory items as the move through a supply chain. However, in alternate embodiments, execution systems 420 can include any type of execution system (or any number of execution systems) that can execute supply chain financial orchestration flows.

According to the embodiment, during execution of supply chain financial orchestration flows, execution systems 420 (such as receiving execution system 421 and inventory execution system 422) can raise events associated with supply chain financial orchestration flows (represented in FIG. 4 as new events 423). Some of these events can be physical execution events. These physical execution events are represented in FIG. 4 as physical execution events 424, 425, and 426. Further, some of these events can indicate an ownership change of an item. Supply chain financial orchestration system 410 can receive the raised events, and determine whether each raised event indicates an ownership change of an item. If a raised event indicates an ownership change of an item, supply chain financial orchestration system 410 can generate one or more trade events. These trade events represented in FIG. 4 as trade events 411, 412, 413, 414, 415, 416, 417, 418, and 419.

According to the embodiment, once supply chain financial orchestration system 410 has generated the trade events, supply chain financial orchestration system 410 can divide the trade events into a set of accrual trade events and a set of costing trade events. The set of accrual trade events can include trade events used to create inter-/intra-company accruals (e.g., trade receipt accruals and/or trade return accruals). The set of costing trade events can include trade events used to book a buy-sell trade agreement (e.g., trade in-transit receipts, trade in-transit issues, trade sales issues, trade in-transit returns, trade in-transit return receipts, and/or trade sales returns).

Supply chain financial orchestration system 410 can send the set of accrual trade events to receipt accounting system 430. Receipt accounting system 430 can receive the accrual trade events from supply chain financial orchestration system 410, perform accounting for the received accrual trade events, and generate one or more trade accounting events based on the received accrual trade events. These trade accounting events are represented in FIG. 4 as trade accounting events 431. Supply chain financial orchestration system 410 can further send the set of costing trade events to cost accounting system 440. Cost accounting system 440 can receive the costing trade events from supply chain financial orchestration system 410, perform accounting for the received costing trade events, and generate one or more trade accounting events based on the received costing trade events. These trade accounting events are represented in FIG. 4 as trade accounting events 441 and 442.

According to the embodiment, inventory execution system 422 can also send one or more physical execution events to cost accounting system 440 via inventory interface 450. Cost accounting system 440 can receive the physical execution events, perform accounting for the received physical execution events, and generate one or more accounting events based on the received physical execution events. These accounting events are represented in FIG. 4 as physical execution events 443. Thus, an accounting of trade events can be independent of an accounting of the physical execution events.

Further, according to the illustrated embodiment, reference data 460 can be sent to cost accounting system 440 via inventory interface 450. Reference data 460 can include one or more accounting attributes used for cost accounting, where the one or more accounting attributes are defined for an agreement (i.e., buy and sell terms) between two entities of a supply chain financial orchestration flow. The one or more accounting attributes can include one or more pricing attributes (which can define a transfer price), one or more accounting template attributes (which can define an accounting template), one or more profit tracking attributes (which can define whether to track mark-ups), etc. Cost accounting system 440 can use the one or more accounting attributes to perform the accounting for the received trade accounting events and/or physical execution events.

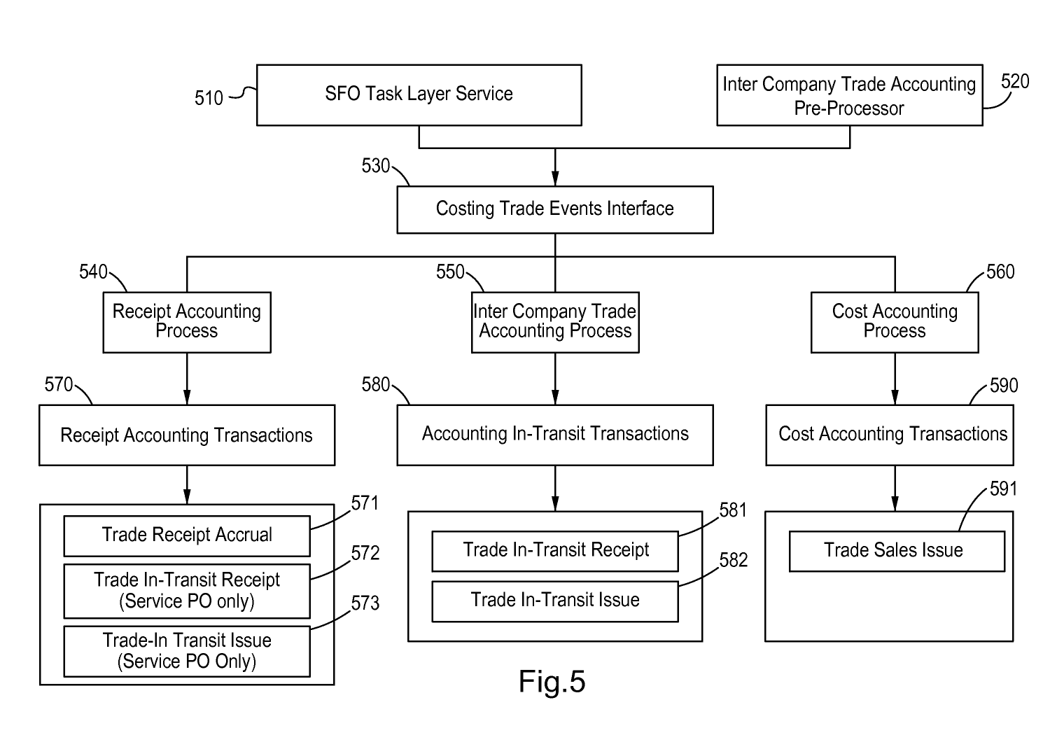

FIG. 5 illustrates an example diagram of a cost accounting system that performs accounting based on trade events received from a supply chain financial orchestration system, according to an embodiment of the invention. The diagram illustrated in FIG. 5 illustrates a trade events interface (i.e., costing trade events interface 530) as a single gateway to get various trade accounting events into a costing system. From the trade events interface, the diagram branches into three different transaction processing models representing different functional states of the trade. The diagram illustrated in FIG. 5 includes supply chain financial orchestration task layer service 510, inter-company trade accounting pre-processor 520, and costing trade events interface 530. Supply chain financial orchestration task layer service 510 is a task layer service of a supply chain financial orchestration system that can send trade events created by the supply chain financial orchestration system to costing trade events interface 530, where the trade events can represent a change in ownership of an item associated with a supply chain financial orchestration flow. Inter-company trade accounting pre-processor 520 is a processing function that can generate trade events that represent a physical execution event associated with a supply chain financial orchestration flow, and that can send the generated trade events to costing trade events interface 530. Costing trade events interface 530 is an interface that can hold all trade events to be accounted by the cost accounting system.

The diagram illustrated in FIG. 5 further includes receipt accounting process 540, intercompany trade accounting process 550, and cost accounting process 560. Receipt accounting process 540 can produce receipt accounting transactions 570, which represent a state of the trade where ownership moves to an entity in a supply chain. Accrued liability can be booked awaiting recognition of an in-transit state of inventory. More specifically, receipt accounting process 540 can receive trade events used to create inter-/intra-company accruals (e.g., trade receipt accruals and/or trade return accruals), and can create and process trade accounting events (more specifically, receipt accounting events). These receipt accounting events are represented in FIG. 5 as accrual accounting events 571, 572, and 573. Intercompany trade accounting process 550 can produce accounting in-transit transactions 580, which represent a state of the trade where the goods are physically in-transit in the physical supply chain, and where the ownership of the goods can potentially pass through one or more entities within the supply chain. This model can identify a current owner of the goods and services irrespective of physical custody of the goods and services. More specifically, intercompany trade accounting process 550 can receive trade events used to book in-transit buy-sell trade agreements (e.g., trade in-transit receipts, trade in-transit issues, trade in-transit returns, and/or trade in-transit return receipts), and can create trade accounting events (more specifically, in-transit cost accounting events). These in-transit cost accounting events are represented in FIG. 5 as in-transit cost accounting events 581 and 582. Cost accounting process 560 can produce cost accounting transactions 590, which represent a state of the trade where the goods are physically received in a location tracked by an overall enterprise. At this point, the inventory valuation can be established. Further, when the goods are eventually sold to an end customer, the inventory can be moved out of the supply chain financial orchestration system, and a COGS can be recorded. More specifically, cost accounting process 560 can receive trade events used to book buy-sell trade agreements (e.g., trade sales issues, and/or trade sales returns), and can create and process trade accounting events (more specifically, cost accounting events). These cost accounting events are represented in FIG. 5 as trade accounting events 591. Cost accounting process 560 can further receive physical execution events, and can create and process accounting events associated with the physical execution events, not shown in FIG. 5.

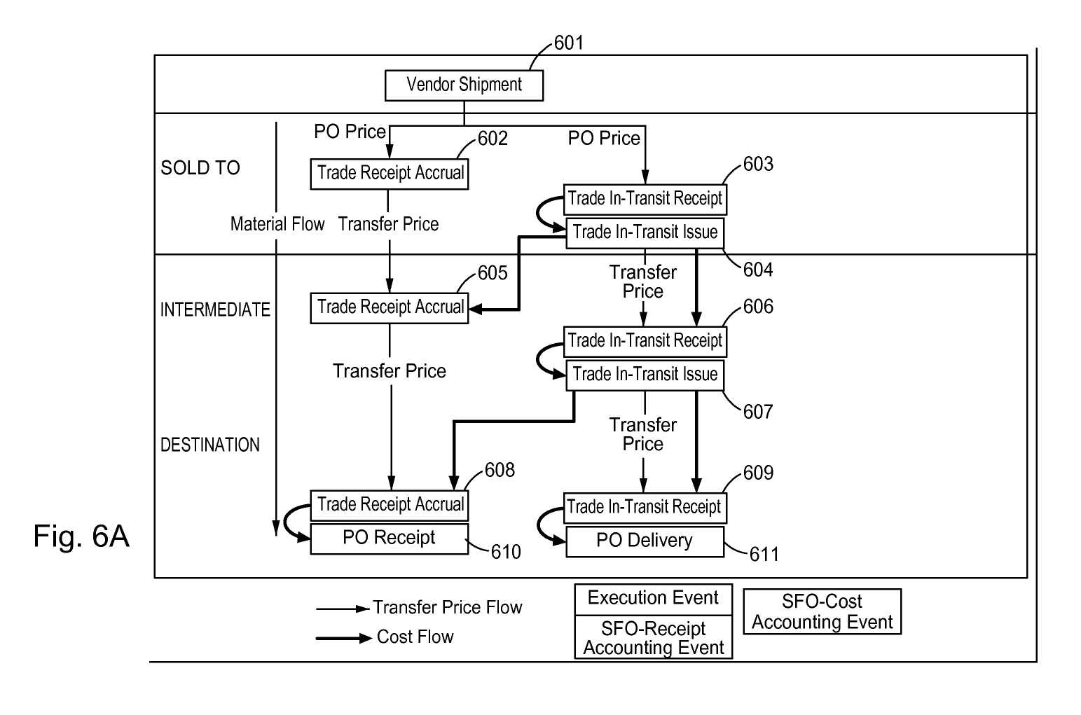

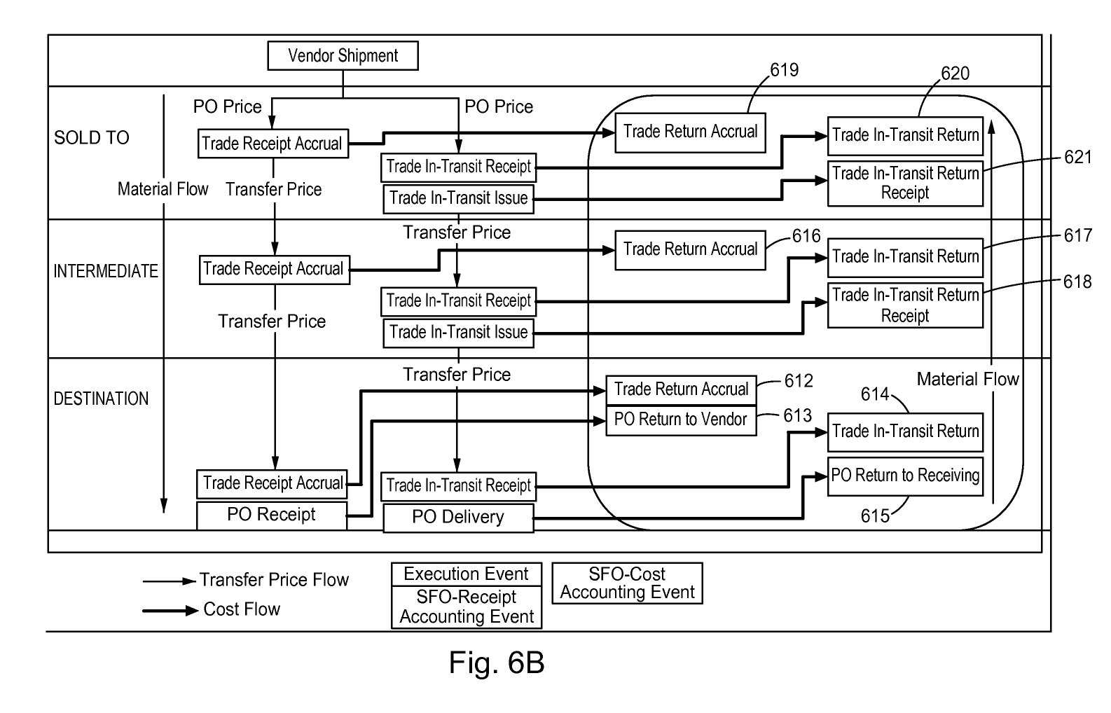

FIG. 6A illustrates trade accounting events generated for a forward flow of a global procurement flow, according to an embodiment of the invention. A global procurement flow is a supply chain financial orchestration flow where the goods are physically delivered by a supplier to a requesting inventory location of an enterprise. However, the financial obligations are borne by a different entity from the entity where the goods are delivered. According to the embodiment, the global procurement flow includes a “sold-to” legal entity, an intermediate legal entity, and a destination legal entity. A sold-to legal entity represents a legal entity and profit center business unit that pays a supplier for the goods purchased. An intermediate legal entity represents a legal entity and profit center business unit that purchases the goods from the sold-to legal entity, and that sells the goods to a downstream entity. A destination legal entity represents a legal entity and profit center business unit that purchases the goods from the intermediate entity, and receives the final physical possession and ownership of goods. Most typically, the trade between the sold-to legal entity and the intermediate legal entity, and the trade between the intermediate legal entity and the destination legal entity happens at a transfer price different from a purchase order price. As described below in greater detail, ownership of the goods moves from the supplier to the sold-to legal entity, from the sold-to legal entity to the intermediate legal entity, and from the intermediate legal entity to the destination legal entity. Further, the flow of costs through the supply chain entities is illustrated in FIG. 6A.

First, a physical execution event, vendor shipment 601, is generated. At this point in the global procurement flow, the ownership of an item associated with the global procurement flow belongs to the sold-to legal entity. Thus, a receipt accounting event, trade receipt accrual 602, is generated, and two cost accounting events, trade in-transit receipt 603 and trade in-transit issue 604, are generated. Subsequently, the ownership of the item is transferred to the intermediate legal entity. Thus, a receipt accounting event, trade receipt accrual 605, is generated, and two cost accounting events, trade in-transit receipt 606 and trade in-transit issue 607, are generated. Subsequently, the ownership of the item is transferred to the destination legal entity. Thus, a receipt accounting event, trade receipt accrual 608, and a cost accounting event, trade in-transit receipt 609, are generated. Further, two physical execution events, PO receipt 610 and PO Delivery 611, are generated. At the destination legal entity, the trade events move the goods out of in-transit, and physical events bring the goods into inventor valuation.

FIG. 6B illustrates trade accounting events generated for a return flow of a global procurement flow, according to an embodiment of the invention. This is the return flow of the forward flow of the global procurement flow, illustrated in FIG. 6A. The main difference, as discussed below in greater detail, is that the goods are physically returned from an original inventory location to a supplier directly, but a refund happens along a different financial path. Financially, the return flow reverses what occurred in the forward flow that is illustrated in FIG. 6A. Similar to the embodiment illustrated in FIG. 6A, the global procurement flow includes a “sold-to” legal entity, an intermediate legal entity, and a destination legal entity. First, a receipt accounting event, trade return accrual 612, and a physical execution event, PO return to vendor 613, are generated. Further, a cost accounting event, trade in-transit return 614, and a physical execution event, PO return to receiving 615, are generated. At this point in the global procurement flow, the ownership of an item associated with the global procurement flow belongs to the destination legal entity. Subsequently, the ownership of the item is transferred back to the intermediate legal entity. Thus, a receipt accounting event, trade return accrual 616, is generated, and two cost accounting events, trade in-transit return 617 and trade in-transit return receipt 618, are generated. Subsequently the ownership of the item is transferred back to the sold-to legal entity. Thus, a receipt accounting event, trade return accrual 619, is generated, and two cost accounting events, trade in-transit return 620 and trade in-transit return receipt 621, are generated.

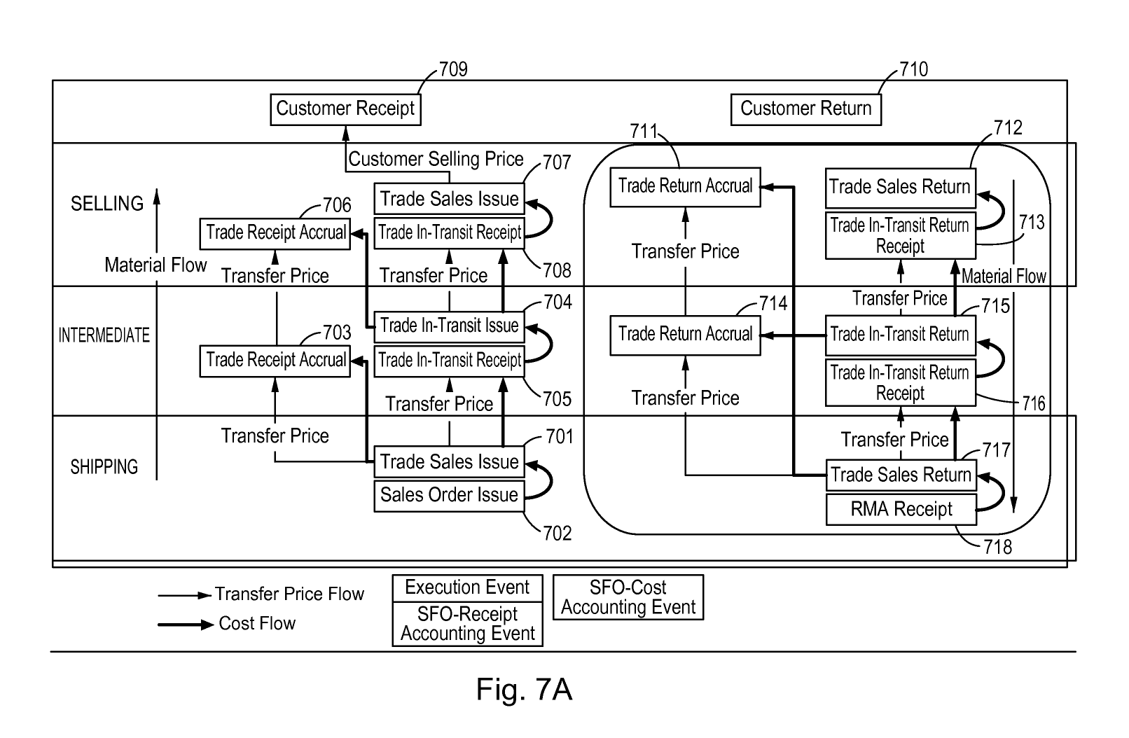

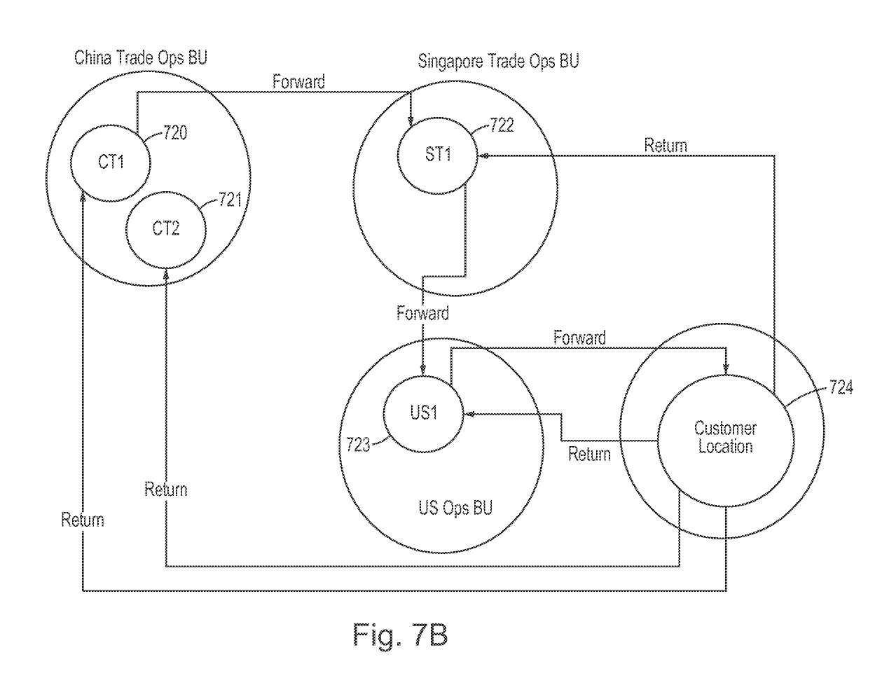

FIG. 7A illustrates trade accounting events generated for a forward flow and a return flow of a customer shipment flow, according to an embodiment of the invention. A customer shipment flow is a supply chain financial orchestration flow where the goods are physically delivered to a customer from a shipping location of an enterprise. However, the financial obligations are borne by a different entity from the entity where the goods are shipped from. According to the embodiment, the customer shipment flow includes a selling legal entity, an intermediate legal entity, and a shipping legal entity. A selling legal entity represents a legal entity and profit center business unit that sells to an end customer. An intermediate legal entity represents a legal entity and profit center business unit that purchases the goods from a shipping legal entity, and that sells the goods to an upstream entity. A shipping legal entity represents a legal entity and profit center business unit that purchases the goods from the intermediate entity, and sells the goods to an end customer. Most typically, the trade between the selling legal entity and the intermediate legal entity, and the trade between the intermediate legal entity and the shipping legal entity happens at a transfer price different from a sales order price. As described below in greater detail, ownership of the goods moves from the shipping legal entity to the intermediate legal entity, from the intermediate legal entity to the selling legal entity, and from the selling legal entity to the end customer. Further, the flow of costs through the supply chain entities is illustrated in FIG. 7A.

First, for a forward flow, a cost accounting event, trade sales issue 701, and a physical execution event, sales order issue 702, are generated. At this point in the customer shipment flow, the ownership of an item associated with the customer shipment flow belongs to the shipping legal entity. Subsequently, the ownership of the item is transferred to the intermediate legal entity. Thus, a receipt accounting event, trade receipt accrual 703, is generated, and two cost accounting events, trade in-transit issue 704 and trade in-transit receipt 705, are generated. Subsequently the ownership of the item is transferred to the selling legal entity. Thus, a receipt accounting event, trade receipt accrual 706, is generated, and two cost accounting events, trade sales issue 707 and trade in-transit receipt 708, are generated. Subsequently, a physical execution event, customer receipt 709, is generated.

For the return flow, a physical execution event, customer return 710, is generated. At this point in the customer shipment flow, the ownership of an item associated with the return flow of the customer shipment flow belongs to the selling legal entity. Thus, a receipt accounting event, trade return accrual 711, is generated, and two cost accounting events, trade sales return 712 and trade in-transit return receipt 713, are generated. Subsequently, the ownership of the item is transferred to the intermediate legal entity. Thus, a receipt accounting event, trade return accrual 714, is generated, and two cost accounting events, trade in-transit return 715 and trade in-transit return receipt 716, are generated. Subsequently, the ownership of the item is transferred to the shipping legal entity. Thus, a cost accounting event, trade sales return 717, and a physical execution event, RMA receipt 718, are generated.

FIG. 7B illustrates forward and return variations of a customer shipment flow, according to an embodiment of the invention. The customer shipment flow is a supply chain financial orchestration flow where the goods are physically returned by an end customer to a location of an enterprise. However, the financial obligation is borne by an entity that is different from an entity where the goods are returned to. According to the embodiment, the customer shipment flow includes two legal entities of a China trade ops business unit, legal entities 720 and 721, a legal entity of a Singapore trade ops business unit, legal entity 722, a legal entity of a United States ops business unit, legal entity 723, and a customer location, customer location 724. As illustrated in FIG. 7B, a forward flow of a customer shipment flow can proceed from legal entity 720 to legal entity 722 to legal entity 723 to legal entity 724. However, as also illustrated in FIG. 7B, a return flow of a customer shipment flow can proceed in one of four manners. First, a return flow can proceed from legal entity 724 to legal entity 723. Second, a return flow can proceed from legal entity 724 to legal entity 722. Third, a return flow can proceed from legal entity 724 to legal entity 721. Fourth, a return flow can proceed from legal entity 724 to legal entity 720.

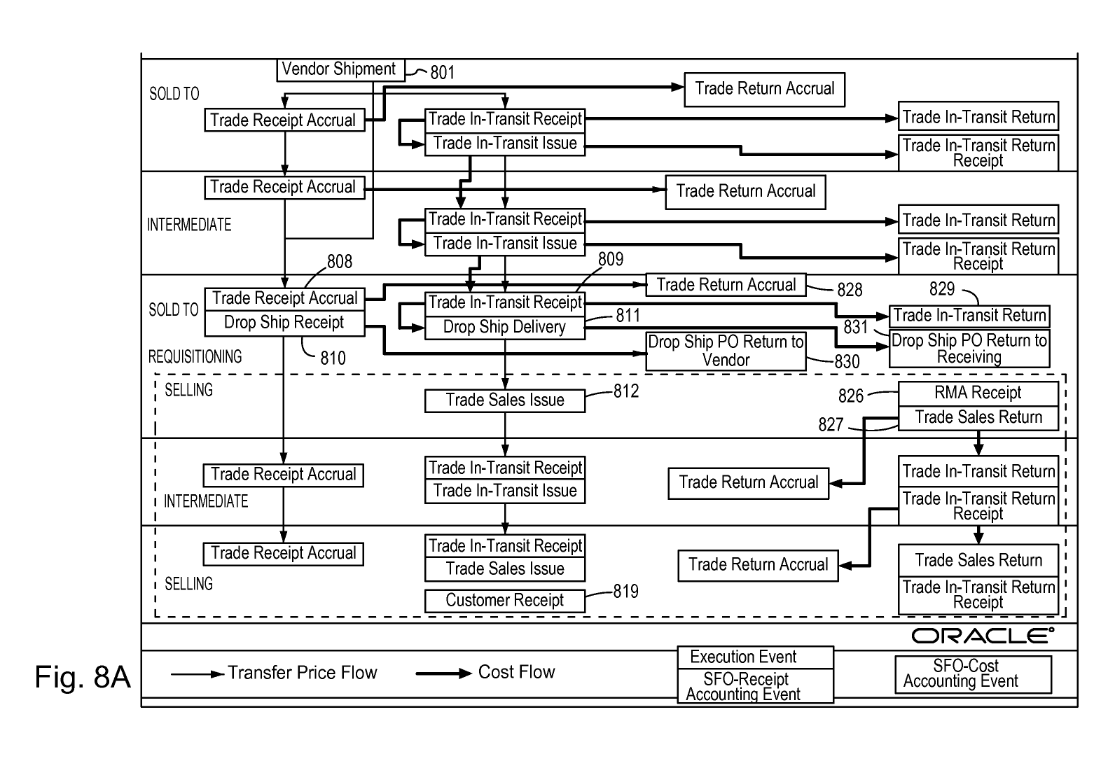

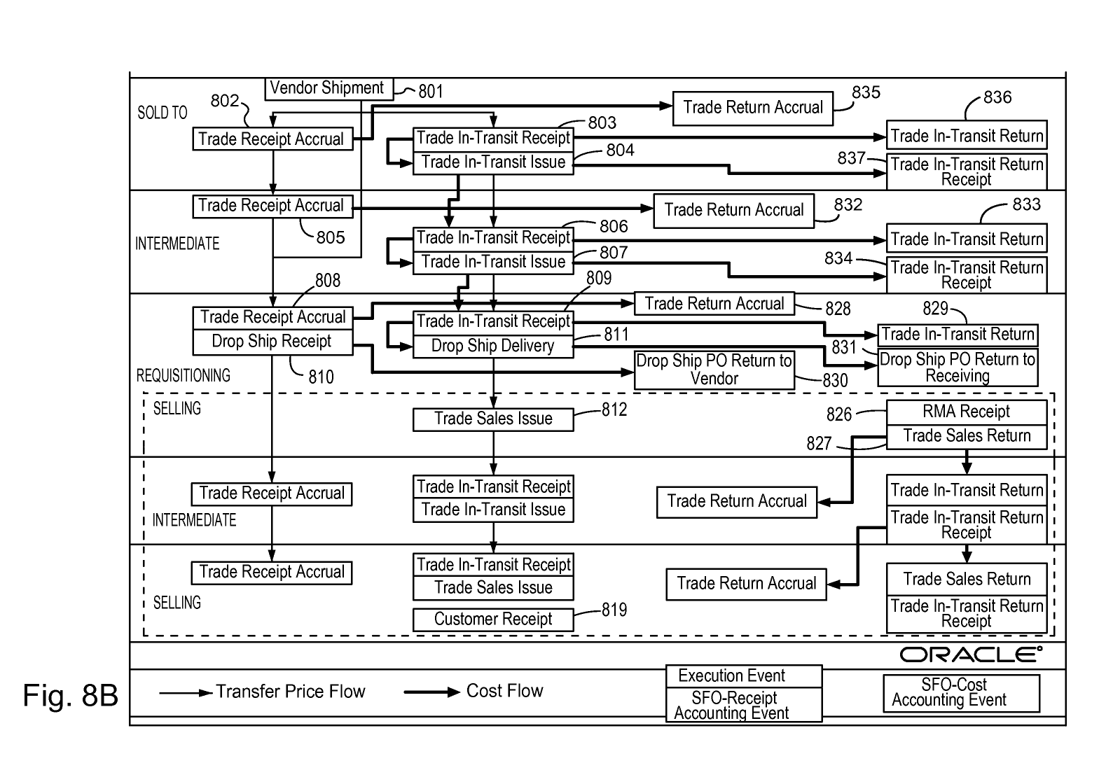

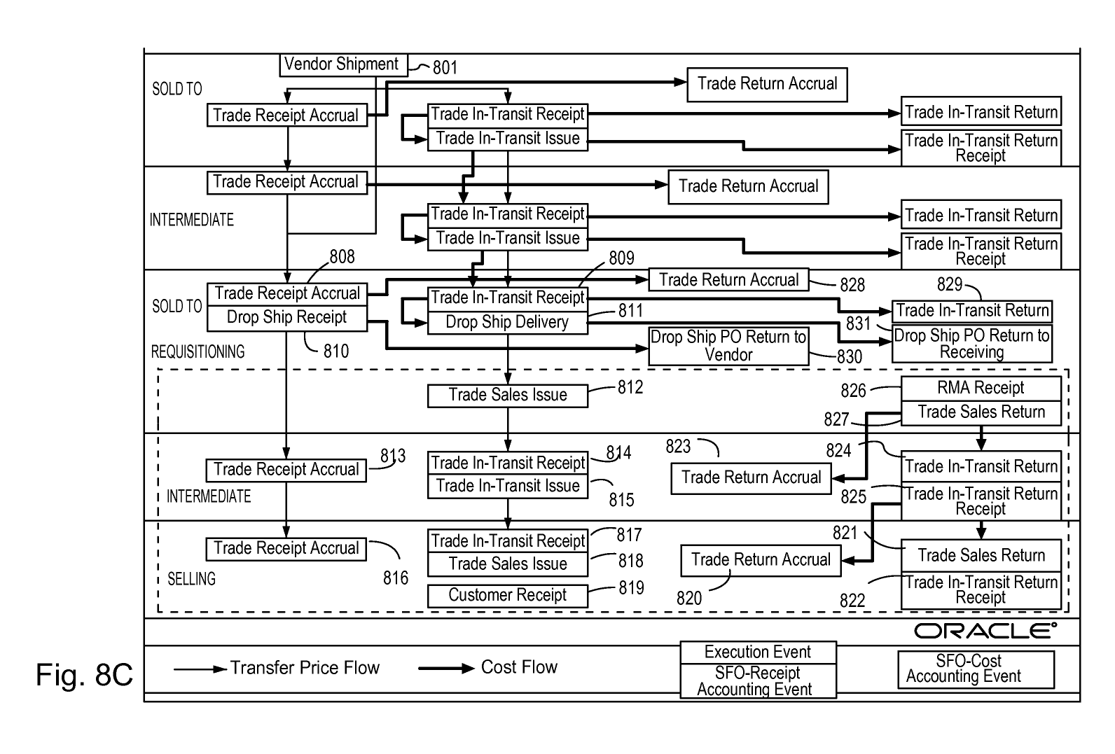

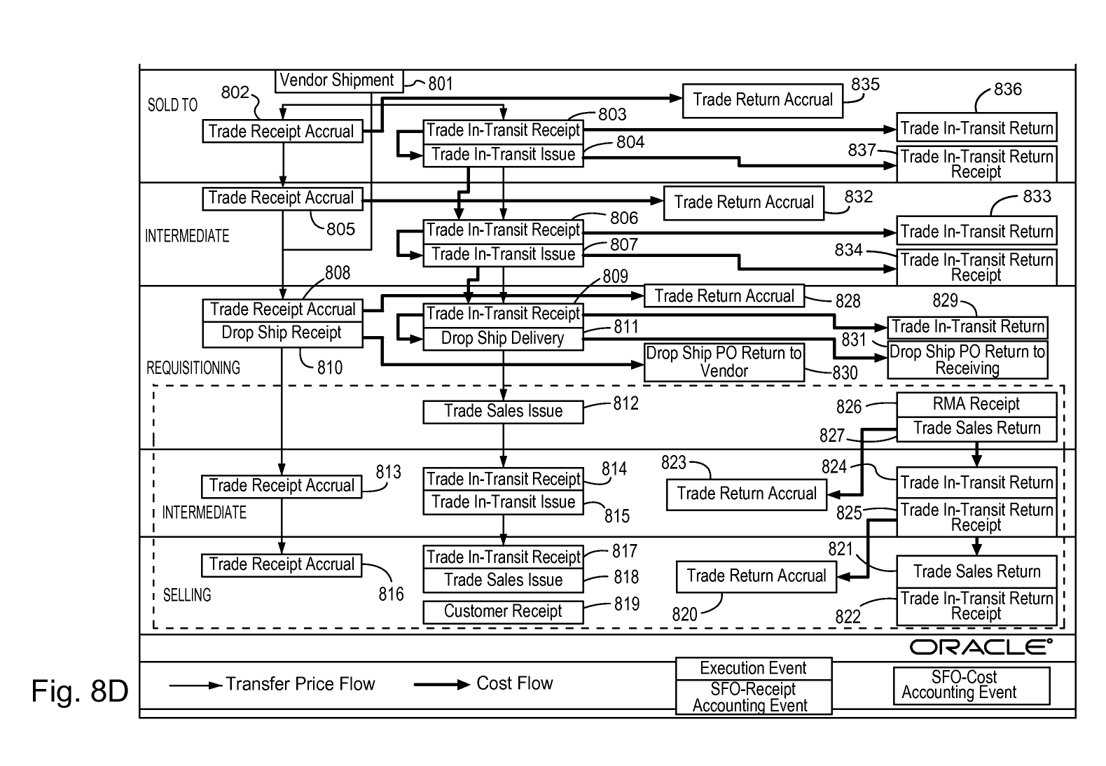

FIGS. 8A, 8B, 8C, and 8D illustrate trade accounting events for a forward flow and a return flow of a customer drop shipment flow for four different scenarios. A customer shipment flow is a supply chain financial orchestration flow where the goods are physically delivered to a customer by the supplier. However, the financial obligations are borne by a different entity from the entity that pays for the purchase. For FIGS. 8A, 8B, 8C, and 8D, the definitions of a shipping legal entity, selling legal entity, intermediate legal entity, and sold-to legal entity are the same as the definitions previously described. Based on the four different scenarios, different legal entities are involved, and are illustrated in the respective figures. A strength of this trade accounting model is that the same trade accounting events remain valid irrespective of the scenario. In other words, each scenario only involves the modification of trading entities, but the trade accounting events remain the same set of trade accounting events.

FIG. 8A illustrates trade accounting events generated for a forward flow and a return flow of a customer drop shipment flow where there is a single business unit drop shipment, according to an embodiment of the invention. According to the embodiment, the single business unit of the customer drop shipment flow is a sold-to legal entity, a requisitioning legal entity, and a selling legal entity. First, for a forward flow, a physical execution event, vendor shipment 801, is generated. At this point in the customer drop shipment flow, the ownership of an item associated with the customer drop shipment flow belongs to the sold-to/requisitioning/selling legal entity. Thus, a receipt accounting event, trade receipt accrual 808, is generated, and a cost accounting event, trade in-transit receipt 809, are generated. Further, two physical execution events, drop shipment receipt 810 and drop shipment delivery 811, are generated. Subsequently, a cost accounting event, trade sales issue 812, and a physical execution event, customer receipt 819, are generated.

For the return flow, a physical execution event, RMA receipt 826, and a cost accounting event, trade sales return 827, are generated. Subsequently, a receipt accounting event, trade return accrual 828, and a cost accounting event, trade in-transit return 829, are generated. Further, two physical execution events, drop shipment PO return to vendor 830, and drop shipment PO return to receiving 831, are generated.

FIG. 8B illustrates trade accounting events generated for a forward flow and a return flow of a customer drop shipment flow where the selling legal entity is also the requisitioning legal entity, according to an embodiment of the invention. According to the embodiment, the customer drop shipment flow includes a sold-to legal entity, an intermediate legal entity, and a selling legal entity (which is also a requisitioning legal entity). First, for a forward flow, a physical execution event, vendor shipment 801, is generated. At this point in the customer drop shipment flow, the ownership of an item associated with the customer drop shipment flow belongs to the sold-to legal entity. Thus, a receipt accounting event, trade receipt accrual 802, is generated, and two cost accounting events, trade in-transit receipt 803 and trade in-transit issue 804, are generated. Subsequently, the ownership of the item is transferred to the intermediate legal entity. Thus, a receipt accounting event, trade receipt accrual 805, is generated, and two cost accounting events, trade in-transit receipt 806 and trade in-transit issue 807, are generated. The ownership of the item is further transitioned to the requisitioning/selling legal entity. Subsequently, a receipt accounting event, trade return accrual 808, and a cost accounting event, trade in-transit receipt 809, are generated. Further, two physical execution events, drop shipment receipt 810, and drop shipment delivery 811, are generated. Subsequently, a cost accounting event, trade sales issue 812, and a physical execution event, customer receipt 819, are generated.

For the return flow, a physical execution event, RMA receipt 826, and a cost accounting event, trade sales return 827, are generated. Subsequently, a receipt accounting event, trade return accrual 828, and a cost accounting event, trade in-transit return 819, are generated. Further, two physical execution events, drop shipment PO return to vendor 830, and drop shipment PO return to receiving 831, are generated. Subsequently, the ownership of the item is transferred to the intermediate legal entity. Thus, a receipt accounting event, trade return accrual 832, is generated, and two cost accounting events, trade in-transit return 833 and trade in-transit return receipt 834, are generated. The ownership of the item is further transitioned to the sold-to legal entity. Thus, a receipt accounting event, trade return accrual 835, is generated, and two cost accounting events, trade in-transit return 836 and trade in-transit return receipt 837, are generated.

FIG. 8C illustrates trade accounting events generated for a forward flow and a return flow of a customer drop shipment flow where the requisitioning legal entity is also the “sold-to” legal entity, according to an embodiment of the invention. According to the embodiment, the customer drop shipment flow includes a sold-to legal entity (which is also a requisitioning legal entity), an intermediate legal entity, and a selling legal entity. First, for a forward flow, a physical execution event, vendor shipment 801, is generated. At this point in the customer drop shipment flow, the ownership of an item associated with the customer drop shipment flow belongs to the sold-to legal entity. Thus, a receipt accounting event, trade return accrual 808, and a cost accounting event, trade in-transit receipt 809, are generated. Further, two physical execution events, drop shipment receipt 810, and drop shipment delivery 811, are generated. Subsequently, a cost accounting event, trade sales issue 812, is generated. The ownership of the item is subsequently transitioned to the intermediate legal entity. Thus, a receipt accounting event, trade receipt accrual 813, is generated, and two cost accounting events, trade in-transit receipt 814 and trade in-transit issue 815, are generated. The ownership of the item is subsequently transitioned to the selling legal entity. Thus, a receipt accounting event, trade receipt accrual 816, is generated, and two cost accounting events, trade in-transit receipt 817 and trade in-transit issue 818, are generated. Subsequently, a physical execution event, customer receipt 819, is generated.

For the return flow, a receipt accounting event, trade return accrual 820, is generated, and two cost accounting events, trade sales return 821 and trade in-transit return receipt 822, are generated. The ownership of the item is subsequently transitioned to the intermediate legal entity. Thus, receipt accounting event, trade return accrual 823, is generated, and two cost accounting events, trade in-transit return 824 and trade in-transit return receipt 825, are generated. The ownership of the item is further transitioned to the requisitioning/sold-to legal entity. Thus, a physical execution event, RMA receipt 826, and a cost accounting event, trade sales return 827, are generated. Subsequently, a receipt accounting event, trade return accrual 828, and a cost accounting event, trade in-transit return 819, are generated. Further, two physical execution events, drop shipment PO return to vendor 830, and drop shipment PO return to receiving 831, are generated.

FIG. 8D illustrates trade accounting events generated for a forward flow and a return flow of a customer drop shipment flow where a sold-to legal entity, requisitioning legal entity, and selling legal entity are all different, according to an embodiment of the invention. First, for a forward flow, a physical execution event, vendor shipment 801, is generated. At this point in the customer drop shipment flow, the ownership of an item associated with the customer drop shipment flow belongs to the sold-to legal entity. Thus, a receipt accounting event, trade receipt accrual 802, is generated, and two cost accounting events, trade in-transit receipt 803 and trade in-transit issue 804, are generated. Subsequently, the ownership of the item is transferred to a first intermediate legal entity. Thus, a receipt accounting event, trade receipt accrual 805, is generated, and two cost accounting events, trade in-transit receipt 806 and trade in-transit issue 807, are generated. The ownership of the item is further transitioned to the requisitioning legal entity. Subsequently, a receipt accounting event, trade return accrual 808, and a cost accounting event, trade in-transit receipt 809, are generated. Further, two physical execution events, drop shipment receipt 810, and drop shipment delivery 811, are generated. Subsequently, a cost accounting event, trade sales issue 812, is generated. The ownership of the item is subsequently transitioned to a second intermediate legal entity. Thus, a receipt accounting event, trade receipt accrual 813, is generated, and two cost accounting events, trade in-transit receipt 814 and trade in-transit issue 815, are generated. The ownership of the item is subsequently transitioned to the selling legal entity. Thus, a receipt accounting event, trade receipt accrual 816, is generated, and two cost accounting events, trade in-transit receipt 817 and trade in-transit issue 818, are generated. Subsequently, a physical execution event, customer receipt 819, is generated.

For the return flow, a receipt accounting event, trade return accrual 820, is generated, and two cost accounting events, trade sales return 821 and trade in-transit return receipt 822, are generated. The ownership of the item is subsequently transitioned to the second intermediate legal entity. Thus, receipt accounting event, trade return accrual 823, is generated, and two cost accounting events, trade in-transit return 824 and trade in-transit return receipt 825, are generated. The ownership of the item is further transitioned to the requisitioning legal entity. Thus, a physical execution event, RMA receipt 826, and a cost accounting event, trade sales return 827, are generated. Subsequently, a receipt accounting event, trade return accrual 828, and a cost accounting event, trade in-transit return 819, are generated. Further, two physical execution events, drop shipment PO return to vendor 830, and drop shipment PO return to receiving 831, are generated. Subsequently, the ownership of the item is transferred to the first intermediate legal entity. Thus, a receipt accounting event, trade return accrual 832, is generated, and two cost accounting events, trade in-transit return 833 and trade in-transit return receipt 834, are generated. The ownership of the item is further transitioned to the sold-to legal entity. Thus, a receipt accounting event, trade return accrual 835, is generated, and two cost accounting events, trade in-transit return 836 and trade in-transit return receipt 837, are generated.

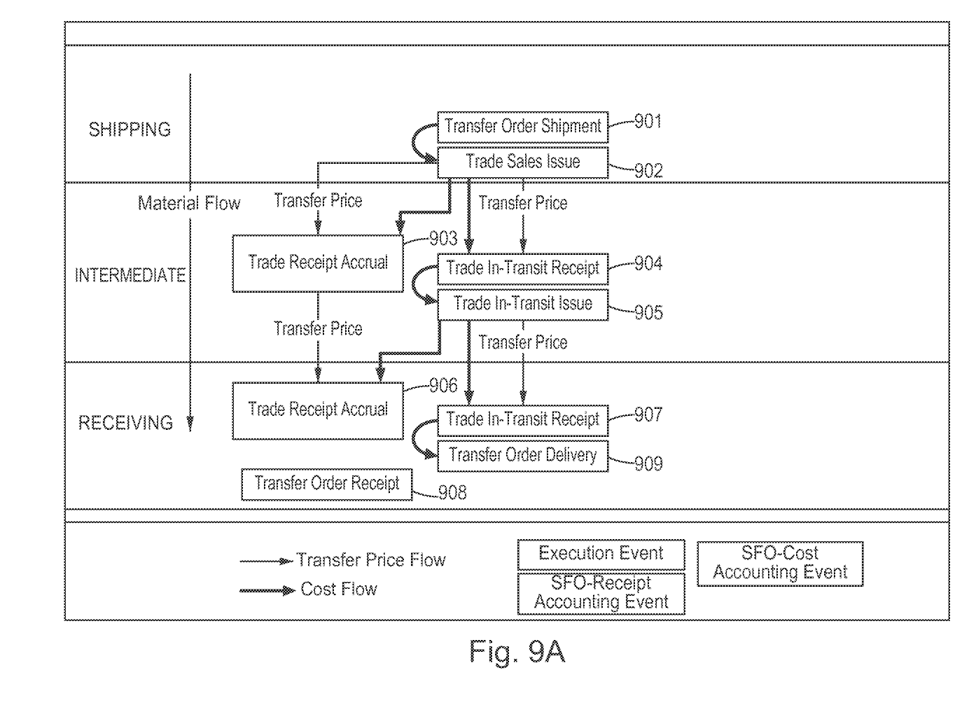

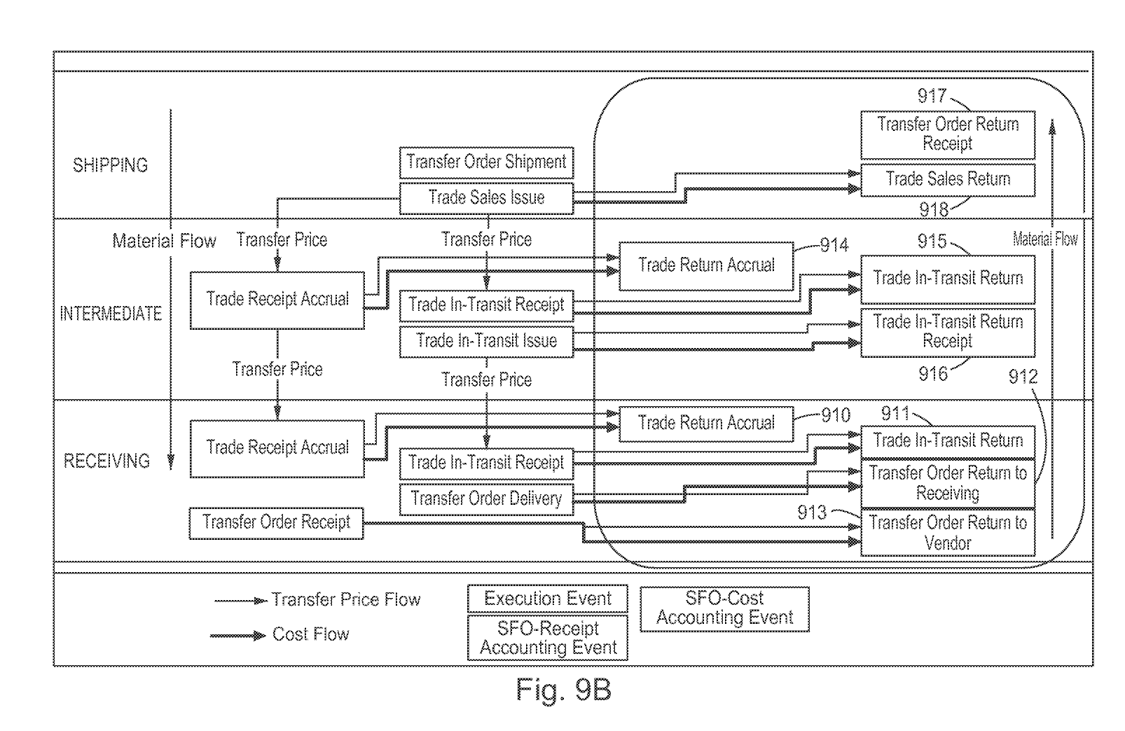

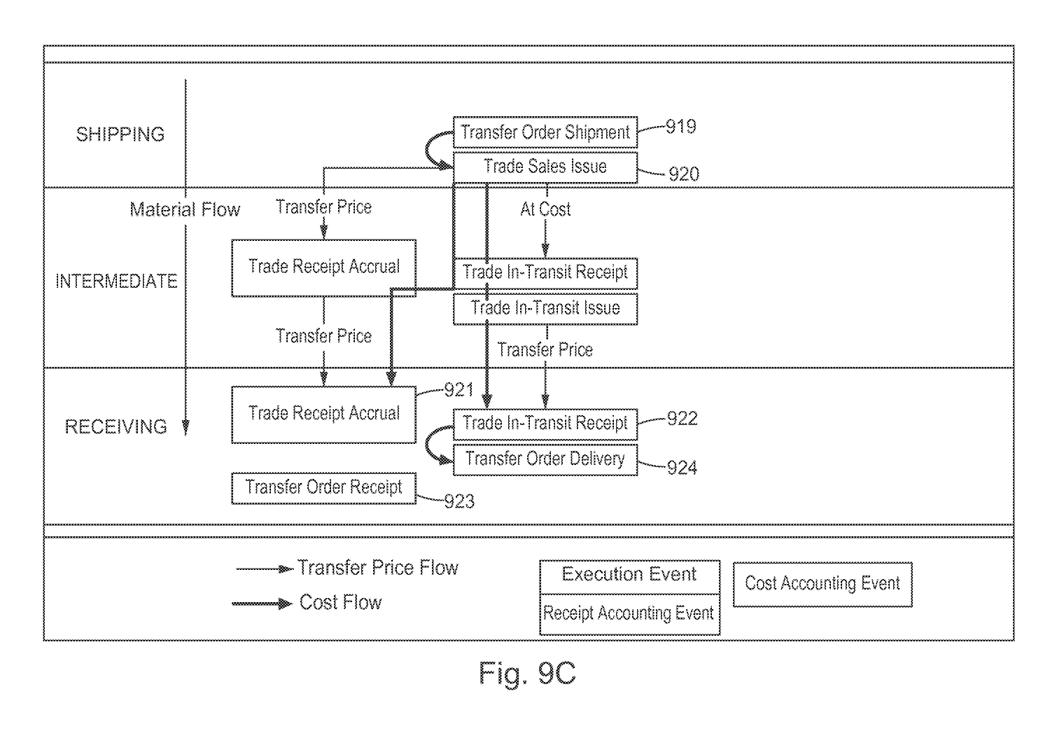

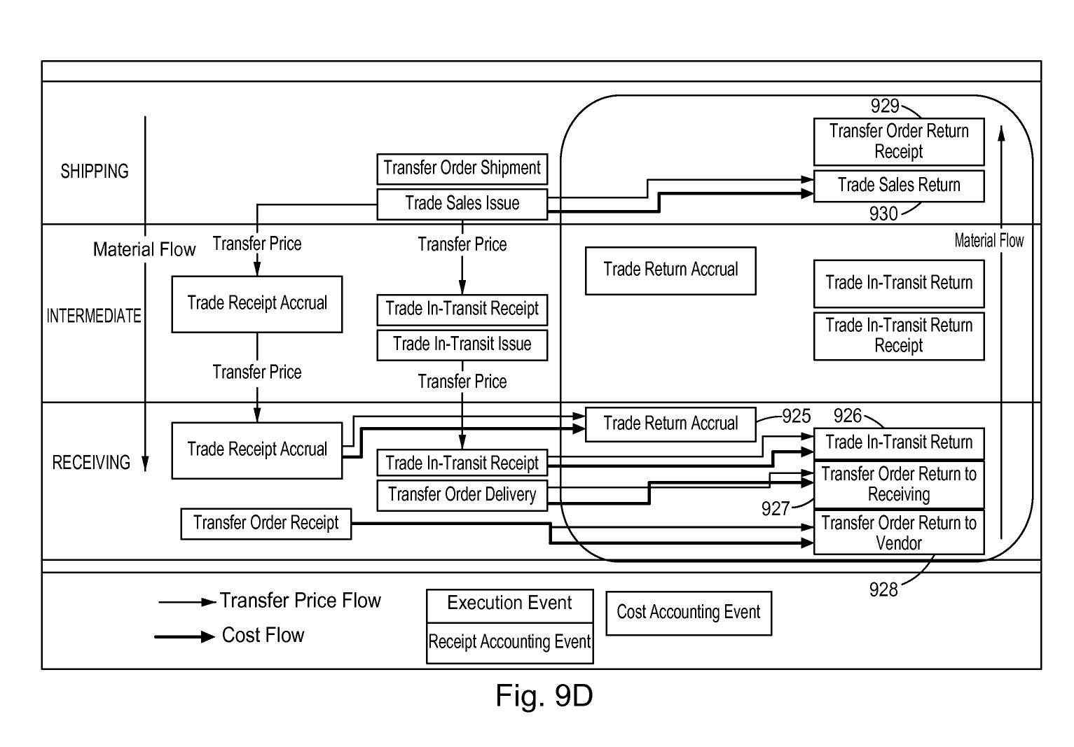

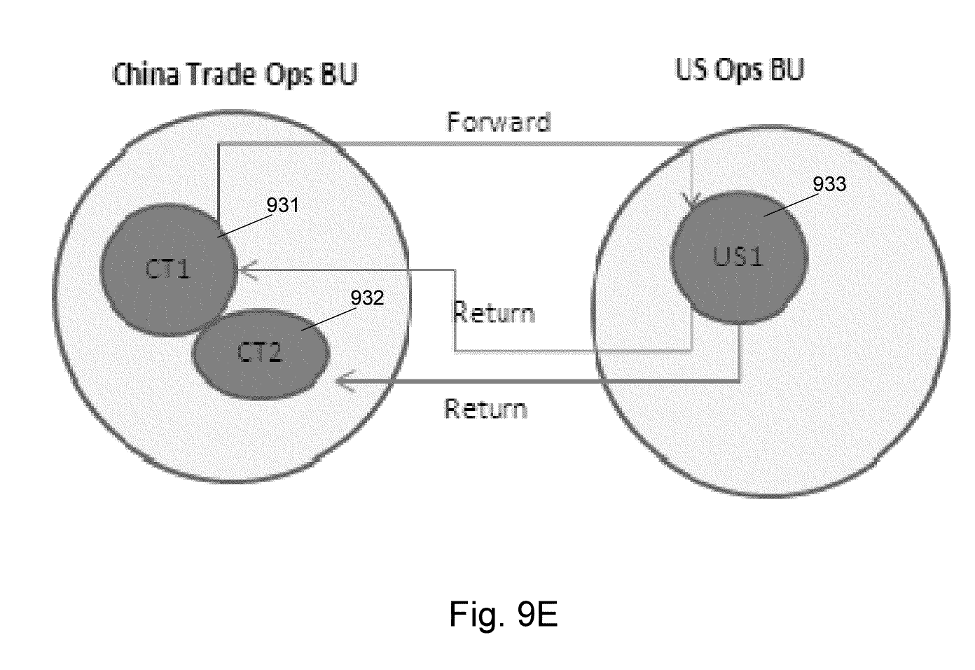

FIG. 9A illustrates trade accounting events generated for a forward flow of an internal transfer flow, according to an embodiment of the invention. An internal transfer flow is a supply chain financial orchestration flow where the goods are physically delivered from a shipping location of an enterprise to another physical location of an enterprise. However, the financial obligations go through one or more intermediate entities. According to the embodiment, the internal transfer flow includes a shipping legal entity, an intermediate legal entity, and a receiving legal entity. A shipping legal entity represents a legal entity and profit center business unit that ships the goods. An intermediate legal entity represents a legal entity and profit center business unit that purchases the goods from the shipping legal entity, and that sells the goods to a downstream entity. A receiving legal entity represents a legal entity and profit center business unit that purchases the goods from the intermediate entity, and also takes physical custody of the goods. Most typically, the trade between the shipping legal entity and the intermediate legal entity, and the trade between the intermediate legal entity and the receiving legal entity happens at a transfer price different from a purchase order price. As described below in greater detail, ownership of the goods moves from the shipping legal entity to the intermediate legal entity, from the intermediate legal entity to the receiving entity, and from the receiving legal entity to a customer. Further, the flow of costs through the supply chain entities is illustrated in FIG. 9A (and in other scenarios, FIGS. 9B, 9C, and 9D).

First, a physical execution event, transfer order shipment 901, is generated. At this point in the internal transfer flow, the ownership of an item associated with the internal transfer flow belongs to the shipping legal entity. Further, a cost accounting event, trade sales issue 902, is generated. Subsequently, the ownership of the item is transferred to the intermediate legal entity. Thus, a receipt accounting event, trade receipt accrual 903, is generated, and two cost accounting events, trade in-transit receipt 904 and trade in-transit issue 905, are generated. Subsequently, the ownership of the item is transferred to the receiving legal entity. Thus, a receipt accounting event, trade receipt accrual 906, and a cost accounting event, trade in-transit receipt 907, are generated. Further, two physical execution events, transfer order receipt 908 and transfer order deliver 909, are generated.

FIG. 9B illustrates trade accounting events generated for a return flow of an internal transfer flow, according to an embodiment of the invention. In the return flow, goods are returned to a shipping location. Costs booked on the forward flow illustrated in FIG. 9A are reversed. Similar to the embodiment illustrated in FIG. 9A, the internal transfer flow includes a shipping legal entity, an intermediate legal entity, and a receiving legal entity. First, a receipt accounting event, trade return accrual 910, and a cost accounting event, trade in-transit return 911, are generated. Further, two physical execution events, transfer order return to receiving 912 and transfer order return to vendor 913, are generated. At this point in the internal transfer flow, the ownership of an item associated with the return flow of the internal transfer flow belongs to the receiving legal entity. Subsequently, the ownership of the item is transferred back to the intermediate legal entity. Thus, a receipt accounting event, trade return accrual 914, is generated, and two cost accounting events, trade in-transit return 915 and trade in-transit return receipt 916, are generated. Subsequently the ownership of the item is transferred back to the shipping legal entity. Thus, a physical execution event, transfer order return receipt 917, and a cost accounting event, trade sales return 918, are generated.

FIG. 9C illustrates trade accounting events generated for a forward flow of an internal transfer flow within a single profit center business unit, according to an embodiment of the invention. This is a supply chain financial orchestration flow where a transfer of goods is within a same business unit. The transfer can happen at cost. Even in this flow, the trade accounting events remain the same. The goods can go out of a physical inventory, can get into an accounting in-transit, and can get into a physical inventory of a receiving legal entity. According to the embodiment, the internal transfer flow includes a shipping legal entity and a receiving legal entity. First, a physical execution event, transfer order shipment 919, is generated. At this point in the internal transfer flow, the ownership of an item associated with the internal transfer flow belongs to the shipping legal entity. Further, a cost accounting event, trade sales issue 920, is generated. Subsequently, the ownership of the item is transferred to the receiving legal entity. Thus, a receipt accounting event, trade receipt accrual 921, and a cost accounting event, trade in-transit receipt 922, are generated. Further, two physical execution events, transfer order receipt 923 and transfer order deliver 924, are generated.

FIG. 9D illustrates trade accounting events generated for a return flow of an internal transfer flow within a single profit center business unit, according to an embodiment of the invention. Similar to the embodiment illustrated in FIG. 9C, the internal transfer flow includes a shipping legal entity and a receiving legal entity. First, a receipt accounting event, trade return accrual 925, and a cost accounting event, trade in-transit return 926, are generated. Further, two physical execution events, transfer order return to receiving 927 and transfer order return to vendor 928, are generated. At this point in the internal transfer flow, the ownership of an item associated with the global procurement flow belongs to the receiving legal entity. Subsequently the ownership of the item is transferred back to the shipping legal entity. Thus, a physical execution event, transfer order return receipt 929, and a cost accounting event, trade sales return 930, are generated.

FIG. 9E illustrates forward and return variations of an internal transfer flow, according to an embodiment of the invention. According to the embodiment, the internal transfer flow includes two legal entities of a China trade ops business unit, legal entities 931 and 932, and a legal entity of a United States ops business unit, legal entity 933. As illustrated in FIG. 9E, a forward flow of a customer shipment flow can proceed from legal entity 931 to legal entity 933. However, as also illustrated in FIG. 9E, a return flow of an internal transfer flow can proceed in one of two manners. First, a return flow can proceed from legal entity 933 to legal entity 931. Second, a return flow can proceed from legal entity 933 to legal entity 932.

In one embodiment, a supply chain financial orchestration system can also include a gross margin reporting data model that can report a gross margin for a supply chain financial orchestration flow. A gross margin is a difference between a revenue associated with an item and a cost associated with the item, before accounting for certain other costs. Generally, a gross margin can be calculated as a difference of a transfer price of an item and a COGS for the item, where a COGS is a cost of the item. According to the embodiment, the gross margin reporting data model can calculate and store a gross margin for each item of a supply chain financial orchestration flow as the item moves through the supply chain financial orchestration flow. Thus, for an internal trade, such as an inter-company trade or an intra-company trade, the gross margin reporting data model can calculate and store a gross margin for each item associated with the internal trade.

In one embodiment, the gross margin reporting data model can include the following elements: (1) revenue data and COGS data can be captured within a standard format that rationalizes disparate sources; (2) key dimensions can be supported (such as business unit, item, item category, inventory organization, cost organization, etc.); and (3) deeper visibility on COGS data (such as cost element, analysis groups, etc.) can be provided. Further, an interactive user interface that analyzes a gross margin and cost structure through the supply chain can be provided. The user interface can provide: (1) multi-dimensional analysis; (2) graphs; and (3) geographic maps with ability to analyze a company's hierarchy and understand associated metrics.

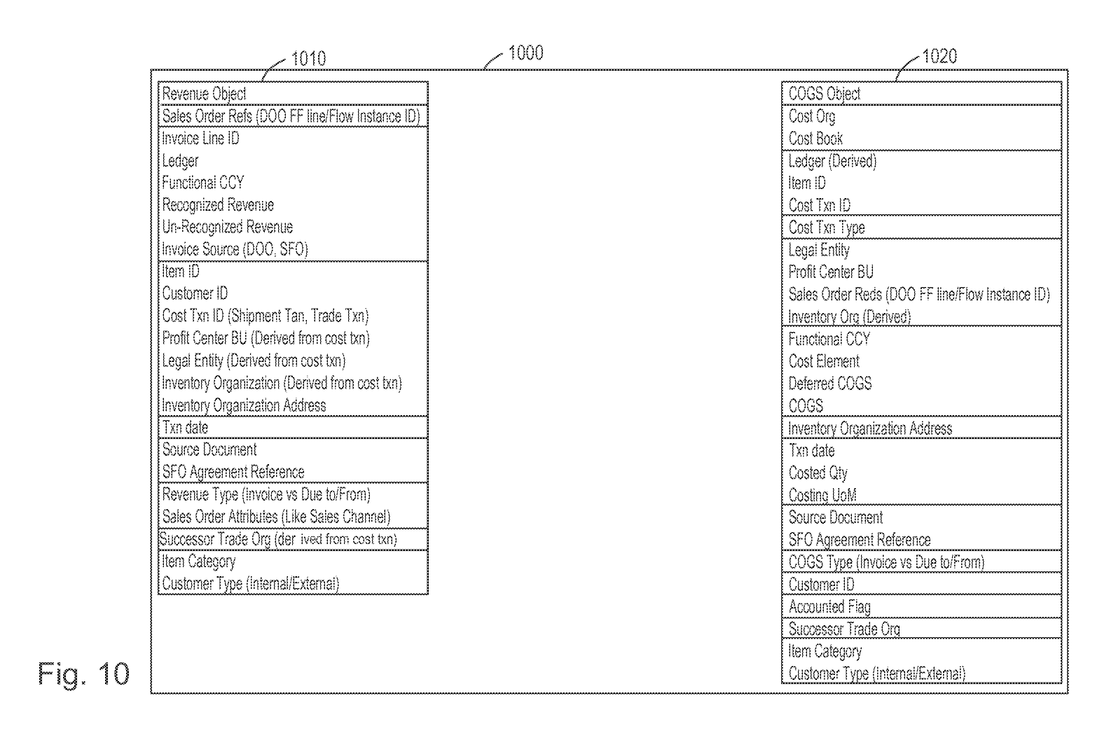

FIG. 10 illustrates an example gross margin reporting data model 1000, according to an embodiment of the invention. Gross margin reporting data model 1000 includes a revenue object 1010. Revenue object 1010 contains revenue data associated with a supply chain financial orchestration flow. The revenue data can be obtained from various sources, such as an accounts receivable interface, and a cost distributions interface. More specifically, the revenue data can be obtained from one or more trade accounting events that are generated and processed by a cost accounting system, where the one or more trade accounting events are based on one or more trade events generated by a supply chain financial orchestration system. The revenue data contained within revenue object 1010 can include: a supply chain financial orchestration flow instance identifier that identifies an instance of a supply chain financial orchestration flow; an item identifier that identifies an item of a supply chain financial orchestration flow; a profit center business unit identifier that identifies a profit center business unit of a supply chain financial orchestration flow; a legal entity identifier that identifies a legal entity of a supply chain financial orchestration flow; and a supply chain financial orchestration agreement identifier that identifies a supply chain financial orchestration agreement associated with a supply chain financial orchestration flow.

Gross margin reporting data model 1000 further includes a COGS object 1020. COGS object 1020 contains COGS data associated with a supply chain financial orchestration flow. The COGS data can be obtained from various sources, such as a cost distributions interface. More specifically, the COGS data can be obtained from one or more trade accounting events that are generated and processed by a cost accounting system, where the one or more trade accounting events are based on one or more trade events generated by a supply chain financial orchestration system. The COGS data contained within COGS object 1020 can include: a supply chain financial orchestration flow instance identifier that identifies an instance of a supply chain financial orchestration flow; an item identifier that identifies an item of a supply chain financial orchestration flow; a profit center business unit identifier that identifies a profit center business unit of a supply chain financial orchestration flow; a legal entity identifier that identifies a legal entity of a supply chain financial orchestration flow; and a supply chain financial orchestration agreement identifier that identifies a supply chain financial orchestration agreement associated with a supply chain financial orchestration flow.

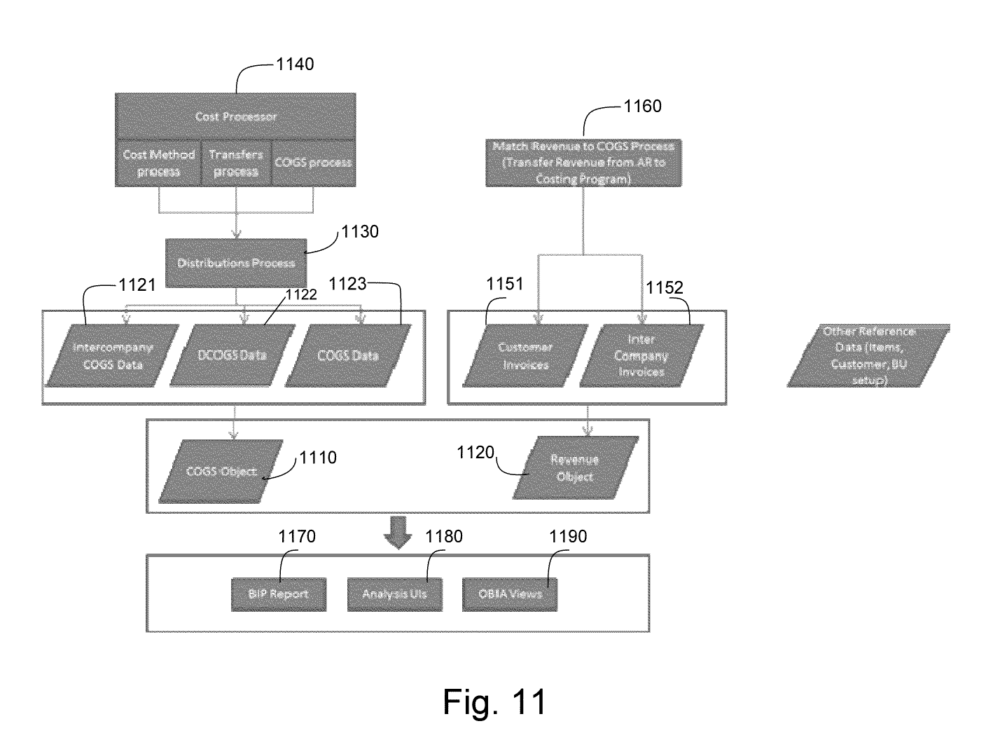

FIG. 11 illustrates a flow diagram for a process that collects COGS and revenue data for a COGS object 1110 and a revenue object 1120 of a gross margin reporting data model, according to an embodiment of the invention. In accordance with the embodiment, the process does the following: (1) identifies multiple sources of revenue and COGS; (2) transforms the multiple sources of revenue and COGS into a unified format of revenue and COGS; (3) defines the unified format of revenue and COGS as a single source of truth used to calculate gross margins; (4) makes the single source of truth available as a source for various presentation options, such as a business intelligence publisher (“BIP”) report, analysis user interface, or other business intelligence too; and (5) reduces the complexity of calculating gross margins, which results in consistent results across different presentation options.

According to the embodiment, COGS object 1110 receives COGS data associated with a supply chain financial orchestration flow from intercompany COGS data 1121, deferred COGS (“DCOGS”) data 1122 and COGS data 1123. Further, intercompany COGS data 1121, DCOGS data 1122, and COGS data 1123 can be generated from distributions process 1130. Distributions process 1130 can generate COGS data based on input from cost processor 1140. Similarly, according to the embodiment, revenue object 1120 receives revenue data associated with a supply chain financial orchestration flow from customer invoices 1151 and intercompany invoices 1152. Further, customer invoices 1151 and intercompany invoices 1152 can be generated from match revenue to COGS process 1160. The COGS data stored within COGS object 1110, and the revenue data stored within revenue object 1120, can be displayed to a user using at least one of, BIP report 1170, analysis user interfaces 1180, or business intelligence applications (“OBIA”) views 1190.

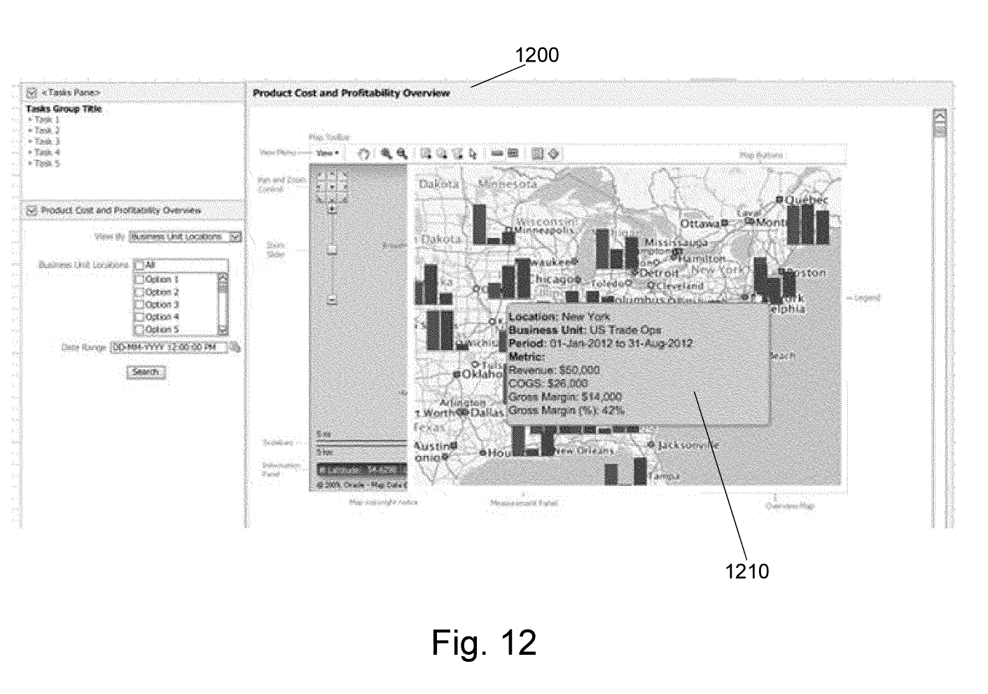

FIG. 12 illustrates an example user interface 1200 of a gross margin reporting data model, according to an embodiment of the invention. According to the embodiment, user interface 1200 includes financial data window 1210. Financial data window 1210 displays financial data for a profit center business unit. According to the illustrated embodiment, financial data window 1210 displays a revenue amount and a COGS amount for the profit center business unit. The revenue amount displayed within financial data window 1210 can be based on revenue data that is retrieved from a revenue object of the gross margin reporting data model associated with the profit center business unit. Further, the COGS amount displayed within financial data window 1210 can be based on COGS data that is retrieved from a COGS object of the gross margin reporting data model associated with the profit center business unit. A gross margin amount and gross margin percentage are each calculated based on the retrieved revenue data and retrieved COGS data, and are also displayed within financial data window 1210.

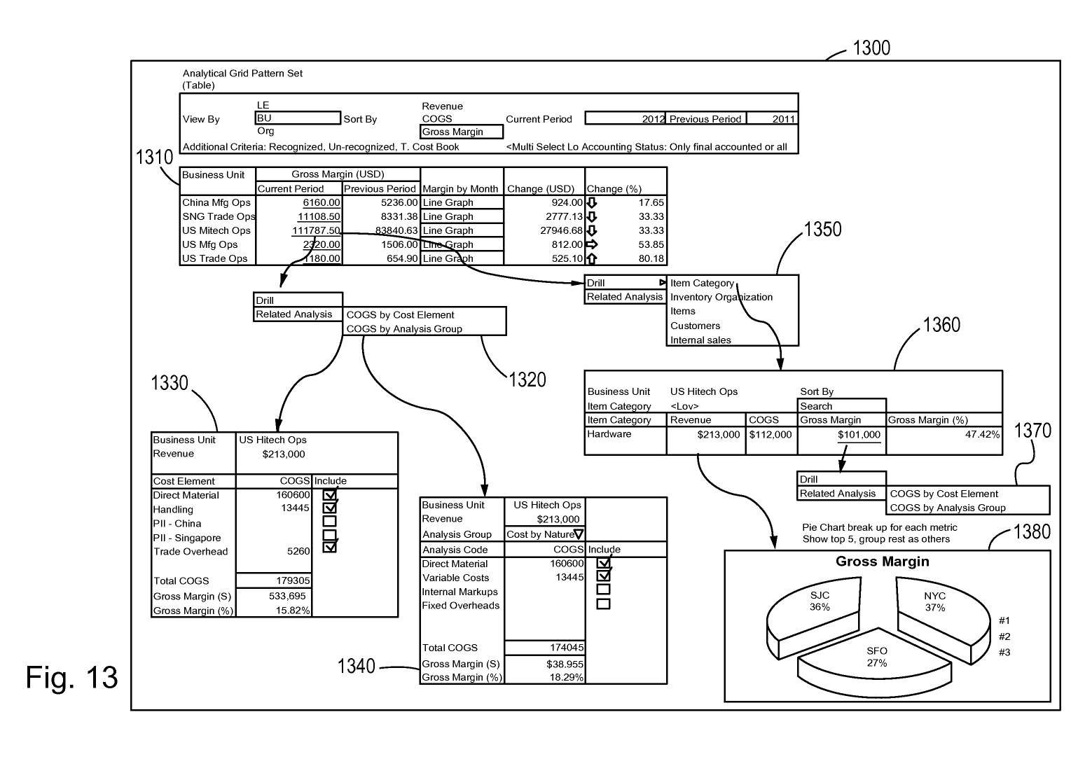

FIG. 13 illustrates another example user interface 1300 of a gross margin reporting data model, according to an embodiment of the invention. According to the embodiment, user interface 1300 includes financial data window 1310. Financial data window 1310 displays financial data for an enterprise. The financial data that is displayed within financial data window 1310 can be sorted by organization, legal entity, or profit center business unit. Further, for each organization, legal entity, or profit center business unit of the enterprise, financial data window can display a revenue amount, a COGS amount, and a gross margin amount of the organization, legal entity, or profit center business unit. The revenue amount of the organization, legal entity, or profit center business unit displayed within financial data window 1310 can be based on revenue data that is retrieved from a revenue object of the gross margin reporting data model associated with each organization, legal entity, or profit center business unit of the enterprise. Further, the COGS amount of the organization, legal entity, or profit center business unit displayed within financial data window 1310 can be based on COGS data that is retrieved from a COGS object of the gross margin reporting data model associated with each organization, legal entity, or profit center business unit of the enterprise. The gross margin amount of the organization, legal entity, or profit center business unit displayed within financial data window 1310 can be calculated based on the retrieved revenue data and retrieved COGS data. The financial data that is displayed within financial data window 1310 can be further sorted by revenue, COGS, or gross margin.

According to the embodiment, a user can either “analyze,” or “drill-down” into, the financial data displayed within financial window 1310, so that user interface 1300 displays more detailed financial data. More specifically, a user can “click” within financial data window 1310 (over a displayed gross margin for a profit center business unit, for example), and can cause analysis window 1320 to be displayed within user interface 1300. Analysis window 1320 allows a user to analyze financial data, such as revenue data or COGS data, according to a characteristic, such as a cost element or an analysis group. In the illustrated embodiment, when a user selects to analyze the COGS data according to a cost element, financial data window 1330 is displayed within user interface 1300, where financial data window 1330 displays COGS data for a profit center business unit that is broken-down by cost element. Financial data window 1330 further displays a total revenue amount for the profit center business unit, a total COGS amount for the profit center business unit, a gross margin amount for the profit center business unit, and a gross margin percentage for the profit center business unit. Further, in the illustrated embodiment, when a user selects to analyze the COGS data according to an analysis group, financial data window 1340 is displayed within user interface 1300, where financial data window 1340 displays COGS data for a profit center business unit that is broken down by analysis group. Financial data window 1340 further displays a total revenue amount for the profit center business unit, a total COGS amount for the profit center business unit, a gross margin amount for the profit center business unit, and a gross margin percentage for the profit center business unit.

Alternatively, a user can “click” within financial data window 1310 (over a displayed gross margin for a profit center business unit, for example), and can cause drill-down window 1350 to be displayed within user interface 1300. Drill-down window 1350 allows a user to drill-down into financial data, such as revenue data or COGS data, according to a characteristic, such as an item category, an inventory organization, and item, a customer, or an internal sale. In the illustrated embodiment, when a user selects to drill-down into the financial data according to an item category (or other characteristic), financial data window 1360 is displayed within user interface 1300, where financial data window 1360 displays a drill-down view of revenue data and COGS data for a profit center business unit based on item category (or other characteristic). Financial data window 1360 further displays a gross margin amount and a gross margin percentage for each item category (or other characteristic).

Further, a user can “click” within financial data window 1360 (over a displayed gross margin for an item category of a profit center business unit, for example), and can cause analysis window 1370 to be displayed within user interface 1300. Analysis window 1370 allows a user to analyze the financial data displayed within financial data window 1360, such as revenue data or COGS data, according to a characteristic, such as a cost element or an analysis group. In the illustrated embodiment, when a user selects to analyze the COGS data according to a cost element, financial data window 1370 is displayed within user interface 1300, where financial data window 1370 displays a pie-chart representation of financial data (such as gross margin percentage) for each cost element of the item category of the business unit.

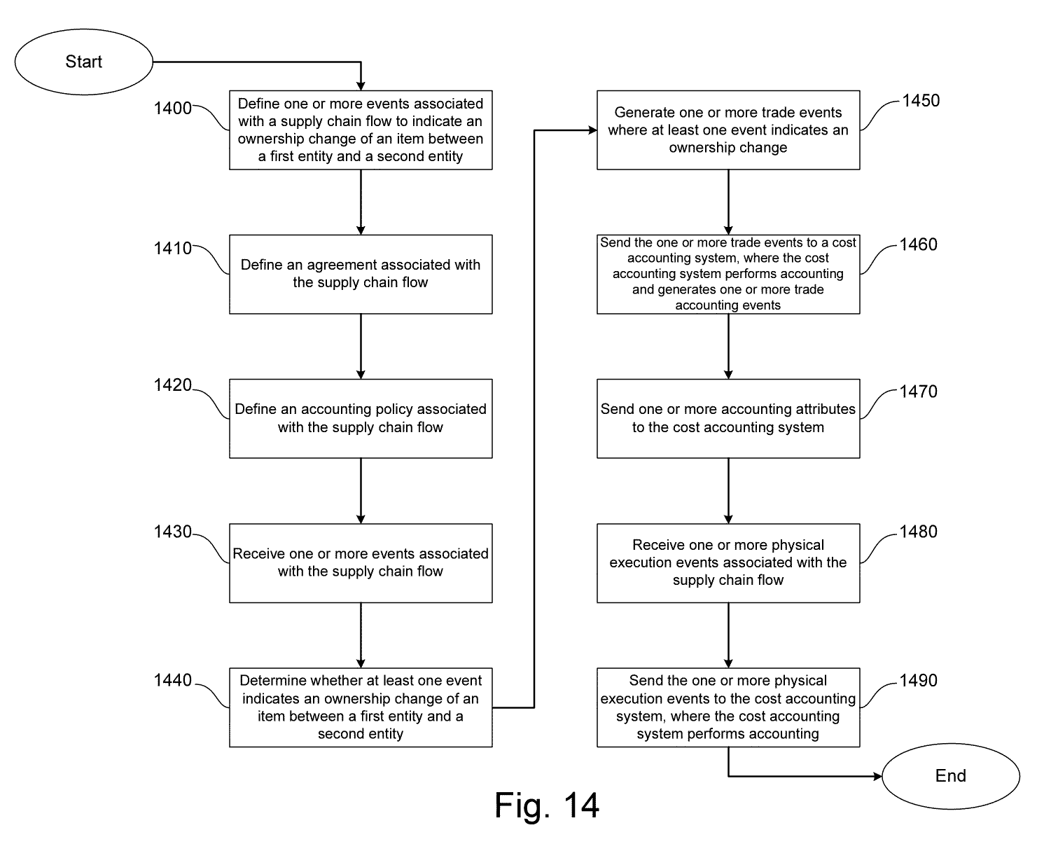

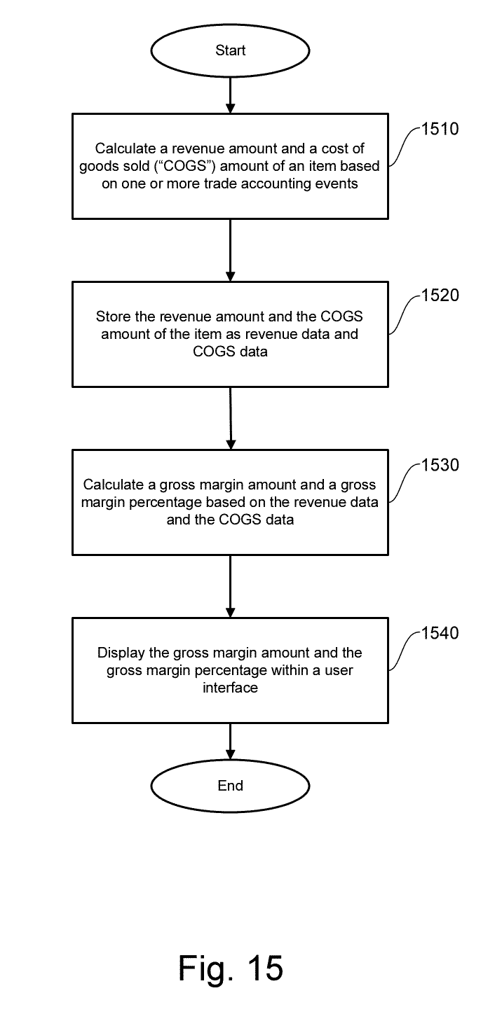

FIG. 14 illustrates a flow diagram of the functionality of a supply chain financial trade accounting module (such as supply chain financial trade accounting module 16 of FIG. 1), according to an embodiment of the invention. In one embodiment, the functionality of the flow diagram of FIG. 14, and the functionality of the flow diagram of FIG. 15, are each implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. Further, certain embodiments may not include all of the functionality of the flow diagram of FIG. 14, or all of the functionality of the flow diagram of FIG. 15.

The flow begins and proceeds to 1400. At 1400, one or more events associated with a supply chain financial orchestration flow are defined to indicate an ownership change of an item between a first entity and a second entity. In certain embodiments, the supply chain financial orchestration flow can be either an inter-company trade or an intra-company trade. The flow then proceeds to 1410.

At 1410, an agreement is defined, where the agreement is associated with the supply chain financial orchestration flow. The agreement can define a transfer price, one or more documentation and accounting rules for the supply chain financial orchestration flow, and one or more transfer pricing rules for the supply chain financial orchestration flow. The flow then proceeds to 1420.

At 1420, an accounting policy is defined, where the accounting policy is associated with the supply chain financial orchestration flow. The accounting policy can define whether an invoice is generated for a trade accounting event, and/or whether a profit is tracked for a trade accounting event. The flow then proceeds to 1430.

At 1430, one or more events associated with the supply chain financial orchestration flow are received. The event(s) can be raised by a transaction associated with the supply chain financial orchestration flow. The flow then proceeds to 1440.

At 1440, it is determined whether at least one event indicates an ownership change of an item between the first entity and the second entity. The flow then proceeds to 1450.

At 1450, one or more trade events are generated where at least one event indicates an ownership change. Each trade event can indicate a change in ownership of the item from the first entity to the second entity. The flow then proceeds to 1460.

At 1460, the one or more trade events are sent to a cost accounting system, where the cost accounting system performs accounting based on the trade event(s), and generates one or more trade accounting events. Each trade accounting event can indicate accounting performed in association with the change in ownership of the item from the first entity to the second entity. The flow then proceeds to 1470.

At 1470, one or more accounting attributes are also sent to the cost accounting system. In these embodiments, the cost accounting system further performs the accounting based on the accounting attribute(s). The accounting attribute(s) can include at least one of: a pricing attribute that defines a transfer price; an accounting template attribute that defines an accounting template that includes one or more documentation and accounting rules and/or one or more transfer pricing rules, or a profit tracking attribute that defines whether to track a profit for the supply chain financial orchestration flow. The flow then proceeds to 1480.

At 1480, one or more physical execution events associated with the supply chain financial orchestration flow are received. Each physical execution event can indicate a physical movement of the item. The flow then proceeds to 1490.

At 1490, the one or more physical execution events are sent to the cost accounting system, where the cost accounting system performs accounting based on the physical execution event(s). Thus, the trade event(s) is/are separate from the physical execution event(s). This means that the accounting that is performed based on the trade event(s) is independent of the accounting that is performed based on the physical execution event(s). The flow then ends.

FIG. 15 illustrates a flow diagram of the functionality of a supply chain financial trade accounting module (such as supply chain financial trade accounting module 16 of FIG. 1) that utilizes a unified gross margin computation model for intercompany trade events as well as physical sales order flows, according to another embodiment of the invention. In certain embodiments, the functionality of the flow diagram of FIG. 15 is implemented after the functionality of the flow diagram of FIG. 14 is implemented.

The flow begins and proceeds to 1510. At 1510, a revenue amount and a COGS amount of an item are calculated based on one or more trade accounting events. The flow then proceeds to 1520. At 1520, the revenue amount and the COGS amount of the item are stored as revenue data and COGS data. The flow then proceeds to 1530. At 1530, a gross margin amount and a gross margin percentage are calculated based on the revenue data and the COGS data. The flow then proceeds to 1540. At 1540, the gross margin amount and the gross margin percentage are displayed within a user interface. The flow then ends.

FIG. 16 illustrates an example supply chain financial orchestration flow, according to an embodiment of the invention. The supply chain financial orchestration flow is between a shipping entity in China and a receiving entity in the United States. As illustrated in FIG. 16, the supply chain financial orchestration flow includes a physical movement flow 1610 and a financial flow 1620. Physical movement flow 1610 represents the physical movement of items from the shipping entity in China, to the receiving entity in the United States, and can involve the physical movement through one or more intermediate entities. Physical movement flow 1610 can include one or more physical transactions that are executed in association with the physical movement of the items (such as shipments, receipts, etc.). Financial flow 1620 represents the change in financial ownership of items from the shipping entity in China, to the receiving entity in the United States, and can involve the change in financial ownership of one or more intermediate entities. Financial flow 1620 can include one or more financial transactions that are executed in association with the change in financial ownership of the items (such as orders, invoices, payments, etc.). As illustrated in FIG. 16, a physical movement flow can be separate and independent of a financial flow within a supply chain financial orchestration system.

FIG. 17 illustrates a block diagram of an example architecture of a supply chain financial orchestration system 1700, according to an embodiment of the invention. According to the embodiment, supply chain financial orchestration system 1700 is a configurable system that manages internal trade relationships between entities belonging to an enterprise, where the enterprise is typically spread across geographies. Supply chain financial orchestration system 1700 can define a nature of trade relationships, business rules, internal controls, regulatory compliances, and other terms and conditions required to execute, monitor, and evaluate trade transactions emanating out of such relationships. More specifically, supply chain financial orchestration system 1700 can listen to events that occur in supply chain transactions in various external source systems, and can identify internal transactions (such as inter-company transactions and intra-company transactions) based on pre-defined trade relationships. Once the internal transactions are identified, supply chain financial orchestration system 1700 can create necessary accounting and documentations required to be generated for the internal transactions according to the business rules defined in supply chain financial orchestration system 1700.

According to the illustrated embodiment, supply chain financial orchestration system 1700 includes event mediator 1701, event capture 1702, event manager 1703, orchestration service 1704, execution manager 1705, task layer service 1706, external interface layer service 1707, connector service 1708, and callback service 1709. Event mediator 1701 listens for events generated by an external source system (i.e., application) of external source systems (i.e., applications) 1710. If an event is of interest to supply chain financial orchestration system 1700, event mediator 1701 can also call a web service exposed by the external source system of external source systems 1710 to enrich the event details. Event mediator 1701 then sends the event to event capture 1702. Event capture 1702 validates the event details retrieved after enrichment, and stores the event in an external source system format.

Subsequently, event manager 1703 identifies a source document enrichment web service based on a source order type, and calls the source document enrichment web service for enrichment. The source document enrichment service is exposed by an external source system of external source systems 1710 where the source order originated. Event manager 1703 can pass a source document identifier as an input parameter to the enrichment web service and can retrieve the source document information, where a source document identifier is a unique identifier of the source document that is communicated to the external source system of external source systems 1710. The external source system of external source systems 1710 that is responsible for capturing the physical transaction can be responsible for passing the source document identifier as part of event information. Supply chain financial orchestration system 1700 can maintain an association between a supply chain event and a source document type. Event manager 1703 can further transform the source document information into a format that is understandable by supply chain financial orchestration system 1700, and can identify a supply chain financial orchestration flow based on qualifiers, source document type, physical route, parties involved in an internal trade, and a priority of the supply chain financial orchestration flow. Further, a supply chain financial orchestration flow can be date effective. This means that any modification to a supply chain financial orchestration flow can cause a new effective date to be associated with the supply chain financial orchestration flow. Thus, transactions pertaining to a source document created before the effective date of the modification can be associated with the original supply chain financial orchestration flow, and transactions pertaining to a source document created after the effective date of the modification can be associated with the modified supply chain financial orchestration flow.

Orchestration service 1704 verifies whether a supply chain financial orchestration flow is already assigned to a source document or not. If the supply chain financial orchestration flow is not already assigned, orchestration service 1704 can assign the supply chain financial orchestration flow to the source document, and can generate the tasks that are to be performed between internal entities based on the documentation and accounting rules setup for the supply chain financial orchestration flow (such as a global procurement flow, a customer shipment flow, and an internal transfer flow). As previously described, a global procurement flow is a supply chain financial orchestration flow where a central buying entity buys goods from suppliers on behalf of one or more internal entities. The supplier liability is borne by the purchasing entity. The purchasing and requesting entity settle the transaction among themselves using a transfer price (sometimes through one or more intermediary entities). A customer shipment flow is a supply chain financial orchestration flow in which a selling business unit is different from a profit center business unit of the entity that owns and ships the goods. The selling entity receives an order from a customer, and the shipping entity ships the goods directly to the customer. The shipping entity is settled financially by the selling entity (sometimes through one or more intermediary entities). A customer shipment flow can be an internal drop shipment flow, which is a forward customer shipment flow, or a customer drop shipment flow, or a return customer shipment flow. An internal transfer flow is a supply chain financial orchestration flow in which physical movement of goods happens between internal entities. The internal entities settle the financial transactions among themselves using a transfer price.

The tasks can be specific to a forward flow and a return flow for the supply chain financial orchestration flow. A forward flow is a flow of events that proceeds in a specific direction (such as from a supplier entity to a purchaser entity), and a return flow is a flow of events that proceeds in a reverse direction (such as from a purchaser entity to a supplier entity). In addition to ownership transfer between internal entities, events indicating ownership transfer from a supplier entity to a purchasing entity can also be setup in a supply chain financial orchestration flow definition. When an event designated as a supplier ownership change event occurs, orchestration service 1704 can generate the tasks for creating trade distributions to book supplier accrual and costs in a costing system, as well. Execution manager 1705 invokes a task layer service based on a task type. Generally, the tasks are performed in a defined sequence, and if there is any dependency from a previous task, execution manager 1705 can wait for the previous task to complete. Example task types can include inter-company trade documents (e.g., purchase order and sales order), trade distribution tasks related to costing, inter-company receivable invoices related to inter-company receivable, payables invoice, or credit memo tasks that are set in documentation and accounting rules. Task types can also include user-defined tasks.

Task layer service 1706 creates a task layer service payload. Task layer service 1706 can include logic to populate the payload data depending on a global procurement flow, a customer shipment flow, or an internal transfer flow. Task layer service 1706 can also call a transfer price service to get a transfer price, where the transfer price is a price in which a selling entity sells goods to a purchasing entity, where the selling entity and the purchasing entity are involved in an internal trade. External interface layer service 1707 identifies a target system (i.e., application) of target systems (i.e., applications) 1720, and obtains a connector service (e.g., connector service 1708) for the target system of target systems 1720 based on the task type. Connector service 1708 transforms the task layer service payload into a format which is understandable by the target system of target systems 1720. Once the task data is transformed according to a target system format, connector service 1708 calls a web service to interface tasks in interface tables of the target system of target systems 1720. Callback service 1709 receives responses from the target system of target systems 1720 and updates the task status. If the task is a last task in a sequence, then the supply chain financial orchestration is complete. Otherwise, the next task in the sequence is selected, and execution manager 1705 is invoked with the task type.

Supply chain financial orchestration system 1700 further includes a supply chain financial orchestration work area 1730 that includes a plurality of user interfaces that allow a user to interact with supply chain financial orchestration system 1700. Supply chain financial orchestration work area 1730 includes manage event exceptions 1731, confirm financial orchestration route assignments 1732, and monitor financial orchestration execution 1733. Manage event exceptions 1731 is a user interface that allows users to view, troubleshoot, and manage events which faulted due to a setup or technical reason. Confirm financial orchestration route assignments 1732 is a user interface that allows a user to confirm a supply chain financial orchestration flow before the tasks of the supply chain financial orchestration flow are initiated by orchestration service 1704. Monitor financial orchestration execution 1733 is a user interface that allows user to monitor supply chain financial orchestration flows that are in progress, that have not started, and that have completed.

Thus, in one embodiment, a supply chain financial orchestration system that includes a trade accounting model is provided. The trade accounting model can provide a separation of physical execution event flows from financial trade buy-sell event flows. This allows for accurate tracking of ownership changes throughout the supply chain financial orchestration flow, even if the ownership change is not coupled with a physical movement. The trade accounting model can also provide an ability to track product costs and internal mark-ups throughout the supply chain to enable true product cost/gross margin visibility, as well as an ability to eliminate internal mark-ups in a consolidated financial statement. These abilities solve some of the largest business problems that large enterprises face. Further, the trade accounting model can also provide an accurate cost accounting of trade buy-sell events and additional overhead costs. This is a functionality not found in many typical ERP systems.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to process trade events, the processing comprising:
receiving one or more events associated with a supply chain financial orchestration flow, wherein the supply chain financial orchestration flow defines a trade relationship between a first entity and a second entity;
determining whether at least one event indicates an ownership change of an item between the first entity and the second entity;
generating one or more trade events where at least one event indicates an ownership change; and
sending the one or more trade events to a cost accounting system;
wherein the cost accounting system performs accounting based on the one or more trade events and generates one or more trade accounting events.

2. The computer-readable medium of claim 1, the processing further comprising:
receiving one or more physical execution events associated with the supply chain financial orchestration flow; and
sending the one or more physical execution events to the cost accounting system;
wherein the cost accounting system performs accounting based on the one or more physical execution events;
wherein the one or more trade events are separate from the one or more physical execution events; and
wherein the accounting that is performed based on the one or more trade events is independent of the accounting that is performed based on the one or more physical execution events.

3. The computer-readable medium of claim 1, the processing further comprising:
calculating a revenue amount and a cost of goods sold (“COGS”) amount of the item based on the one or more trade accounting events;
storing the revenue amount and the COGS amount of the item as revenue data and COGS data;
calculating a gross margin amount and a gross margin percentage based on the revenue data and the COGS data; and
displaying the gross margin amount and the gross margin percentage within a user interface.

4. The computer-readable medium of claim 1, the processing further comprising:
defining one or more events associated with the supply chain financial orchestration flow to indicate an ownership change of an item between a first entity and a second entity.

5. The computer-readable medium of claim 1, the processing further comprising:
sending one or more accounting attributes to the cost accounting system;
wherein the cost accounting system further performs the accounting based on the one or more accounting attributes; and
wherein the one or more accounting attributes comprises at least one of: a pricing attribute that defines a transfer price; an accounting template attribute that defines an accounting template comprising one or more documentation and accounting rules and one or more transfer pricing rules; or a profit tracking attribute that defines whether to track a profit for the supply chain financial orchestration flow.

6. The computer-readable medium of claim 1, the processing further comprising:
defining an agreement associated with the supply chain financial orchestration flow;
wherein the agreement defines a transfer price, one or more documentation and accounting rules, and one or more transfer pricing rules.

7. The computer-readable medium of claim 1, the processing further comprising:
defining an accounting policy associated with the supply chain financial orchestration flow;
wherein the accounting policy defines whether an invoice is generated for a trade accounting event, and whether a profit is tracked for the supply chain financial orchestration flow.

8. The computer-readable medium of claim 1, wherein the one or more events are raised by a transaction associated with the supply chain financial orchestration flow.

9. The computer-readable medium of claim 1, wherein each trade event indicates a change in ownership of the item from the first entity to the second entity;
wherein each trade accounting event indicates accounting performed in association with the change in ownership of the item from the first entity to the second entity; and
wherein each physical execution event indicates a physical movement of the item.

10. The computer-readable medium of claim 1, wherein the supply chain financial orchestration flow comprises one of: an inter-company trade; or an intra-company trade.

11. A computer-implemented method for processing trade events, the computer-implemented method comprising:
receiving one or more events associated with a supply chain financial orchestration flow, wherein the supply chain financial orchestration flow defines a trade relationship between a first entity and a second entity;
determining whether at least one event indicates an ownership change of an item between a first entity and a second entity;
generating one or more trade events where at least one event indicates an ownership change; and
sending the one or more trade events to a cost accounting system;
wherein the cost accounting system performs accounting based on the one or more trade events and generates one or more trade accounting events.

12. The computer-implemented method of claim 11, further comprising:
receiving one or more physical execution events associated with the supply chain financial orchestration flow; and
sending the one or more physical execution events to the cost accounting system;
wherein the cost accounting system performs accounting based on the one or more physical execution events;
wherein the one or more trade events are separate from the one or more physical execution events; and
wherein the accounting that is performed based on the one or more trade events is independent of the accounting that is performed based on the one or more physical execution events.

13. The computer-implemented method of claim 11, further comprising:
calculating a revenue amount and a cost of goods sold (“COGS”) amount of the item based on the one or more trade accounting events;
storing the revenue amount and the COGS amount of the item as revenue data and COGS data;
calculating a gross margin amount and a gross margin percentage based on the revenue data and the COGS data; and
displaying the gross margin amount and the gross margin percentage within a user interface.

14. The computer-implemented method of claim 11, further comprising:
defining one or more events associated with the supply chain financial orchestration flow to indicate an ownership change of an item between a first entity and a second entity.

15. The computer-implemented method of claim 11, further comprising:
sending one or more accounting attributes to the cost accounting system;
wherein the cost accounting system further performs the accounting based on the one or more accounting attributes; and
wherein the one or more accounting attributes comprises at least one of: a pricing attribute that defines a transfer price; an accounting template attribute that defines an accounting template comprising one or more documentation and accounting rules and one or more transfer pricing rules; or a profit tracking attribute that defines whether to track profit for the supply chain financial orchestration flow.

16. A system, comprising:
an event reception module configured to receive one or more events associated with a supply chain financial orchestration flow, wherein the supply chain financial orchestration flow defines a trade relationship between a first entity and a second entity;
an ownership determination module configured to determine whether at least one event indicates an ownership change of an item between a first entity and a second entity;
a trade event generation module configured to generate one or more trade events where at least one event indicates an ownership change; and
a trade event interface module configured to send the one or more trade events to a cost accounting system;
wherein the cost accounting system performs accounting based on the one or more trade events and generates one or more trade accounting events.

17. The system of claim 16,
wherein the event reception module is further configured to receive one or more physical execution events associated with the supply chain financial orchestration flow;
wherein the trade events module is further configured to send the one or more physical execution events to the cost accounting system;
wherein the cost accounting system performs accounting based on the one or more physical execution events;
wherein the one or more trade events are separate from the one or more physical execution events; and
wherein the accounting that is performed based on the one or more trade events is independent of the accounting that is performed based on the one or more physical execution events.

18. The system of claim 16, further comprising:
a financial data calculation module configured to calculate a revenue amount and a cost of goods sold (“COGS”) amount of the item based on the one or more trade accounting events;
a financial data storage module configured to store the revenue amount and the COGS amount of the item as revenue data and COGS data;
a gross margin calculation module configured to calculate a gross margin amount and a gross margin percentage based on the revenue data and the COGS data; and
a gross margin display module configured to display the gross margin amount and the gross margin percentage within a user interface.

19. The system of claim 16, further comprising:
an ownership definition module configured to define one or more events associated with the supply chain financial orchestration flow to indicate an ownership change of an item between a first entity and a second entity.

20. The system of claim 16,
wherein the trade event interface module is further configured to send one or more accounting attributes to the cost accounting system;
wherein the cost accounting system further performs the accounting based on the one or more accounting attributes; and
wherein the one or more accounting attributes comprises at least one of: a pricing attribute that defines a transfer price; an accounting template attribute that defines an accounting template comprising one or more documentation and accounting rules and one or more transfer pricing rules; or a profit tracking attribute that defines whether to track profit for the supply chain financial orchestration flow.
